(19) United States
(12) Patent Application Publication
(10) Pub. No.: US 2026/0195929 A1
(43) Pub. Date: Jul. 9, 2026

(54) POINT CLOUD DECODING DEVICE, POINT CLOUD DECODING METHOD, AND NON-TRANSITORY COMPUTER-READABLE MEDIUM

(71) Applicant: KDDI CORPORATION, Tokyo (JP)

(72) Inventors: Kyohei UNNO, Fujimino-shi (JP); Keisuke NONAKA, Fujimino-shi (JP); Kei KAWAMURA, Fujimino-shi (JP)

(73) Assignee: KDDI CORPORATION, Tokyo (JP)

(21) Appl. No.: 19/554,433

(22) Filed: Mar. 2, 2026

Related U.S. Application Data
(63) Continuation of application No. PCT/JP2024/042927, filed on Dec. 4, 2024.

(30) Foreign Application Priority Data
Jan. 12, 2024 (JP) 2024-003516

(51) Int. Cl. G06T 9/40

(52) U.S. Cl. CPC G06T 9/40

(57) ABSTRACT

A point cloud decoding device 200 includes: a RAHT unit 2080 configured to predict information on a chroma Cr signal of a decoding target node by using information on a chroma Cb signal of the decoding target node.

### CROSS-REFERENCE TO RELATED APPLICATIONS

The present application is a continuation of PCT Application No. PCT/JP2024/042927, filed on Dec. 4, 2024, which claims the benefit of Japanese patent application No. 2024-003516 filed on Jan. 12, 2024, the entire contents of each application being incorporated herein by reference in its entirety.

### TECHNICAL FIELD

The present invention relates to a point cloud decoding device, a point cloud decoding method, and a non-transitory computer-readable medium.

### BACKGROUND ART

Conventionally, in RAHT, each color signal is encoded/decoded independently for each component.

### SUMMARY OF THE INVENTION

However, in the RAHT, the correlation between the color signals cannot be utilized, and there is a problem that there is room for reduction in the code amount.

Therefore, the present invention has been made in view of the above-described problems, and an object thereof is to provide a point cloud decoding device, a point cloud decoding method, and a program, which can improve the encoding efficiency of encoding attribute information.

The first aspect of the present invention is summarized as a point cloud decoding device including: a RAHT unit configured to predict information on a chroma Cr signal of a decoding target node by using information on a chroma Cb signal of the decoding target node.

The second aspect of the present invention is summarized as a point cloud decoding method, including: predicting information on a chroma Cr signal of a decoding target node by using information on a chroma Cb signal of the decoding target node.

The third aspect of the present invention is summarized as a non-transitory computer-readable medium having stored thereon a program for causing a computer to function as a point cloud decoding device, wherein the point cloud decoding device includes a RAHT unit configured to predict information on a chroma Cr signal of a decoding target node by using information on a chroma Cb signal of the decoding target node.

According to the present invention, it is possible to provide a point cloud decoding device, a point cloud decoding method, and a program, which can improve the encoding efficiency of encoding attribute information.

### BRIEF DESCRIPTION OF THE DRAWINGS

FIG. 1 is a diagram illustrating an example of a configuration of a point cloud processing system 10 according to an embodiment.

FIG. 2 is a diagram illustrating an example of functional blocks of a point cloud decoding device 200 according to an embodiment.

FIG. 3 is a diagram illustrating an example of a configuration of encoded data (bit stream) received by a geometry information decoding unit 2010 of the point cloud decoding device 200 according to an embodiment.

FIG. 4 is a diagram illustrating an example of a syntax configuration of a geometry parameter set (GPS) 2011.

FIG. 5 is an example of a configuration of encoded data (bit stream) received by an attribute-information decoding unit 2060 of the point cloud decoding device 200 according to an embodiment.

FIG. 6 is an example of a syntax configuration of an APS 2611 illustrated in FIG. 5.

FIG. 7 is a flowchart illustrating an example of processing of the RAHT unit 2080.

FIG. 8 is a flowchart illustrating an example of processing in Step S28004.

FIG. 9 is a flowchart illustrating an example of processing in Step S28104.

FIG. 10 is a flowchart illustrating an example of processing of intra prediction in Step S28112.

FIG. 11 is a diagram illustrating a relationship between a decoding target node and an adjacent node in a higher-level hierarchy.

FIG. 12 is a diagram illustrating a relationship between the decoding target node and an adjacent node in a subnode hierarchy.

FIG. 13 is a flowchart illustrating an example of processing of intra prediction in Step S28112.

FIG. 14 is a flowchart illustrating an example of processing of the RAHT unit 2080.

FIG. 15 is a diagram illustrating an example of inter prediction processing in Step S28111.

FIG. 16 is a flowchart illustrating an example of operation of the tree synthesizing unit 2020 of the point cloud decoding device 200 according to an embodiment.

FIG. 17 is a flowchart illustrating an example of processing of decoding predictor information and a spherical coordinate residual in Step S1604.

FIG. 18 is a diagram illustrating an example of functional blocks of a point cloud encoding device 100 according to the present embodiment.

FIG. 19 is a flowchart illustrating an example of adjacent node search processing of the higher-level hierarchy of the decoding target node.

FIG. 20 is a flowchart illustrating an example of the adjacent node search processing of the higher-level hierarchy of the decoding target node.

FIG. 21 is a flowchart illustrating an example of the adjacent node search processing of the higher-level hierarchy of the decoding target node.

FIG. 22 is a flowchart illustrating an example of processing in Step S28103.

FIG. 23 is a flowchart illustrating an example of processing of the intra prediction in Step S28112.

FIG. 24 illustrates an example of the syntax configuration of the APS 2611 illustrated in FIG. 5.

### DETAILED DESCRIPTION

An embodiment of the present invention will be described hereinbelow with reference to the drawings. Note that the constituent elements of the embodiment below can, where appropriate, be substituted with existing constituent elements and the like, and that a wide range of variations, including combinations with other existing constituent elements, is possible. Therefore, there are no limitations placed on the content of the invention as in the claims on the basis of the disclosures of the embodiment hereinbelow.

### First Embodiment

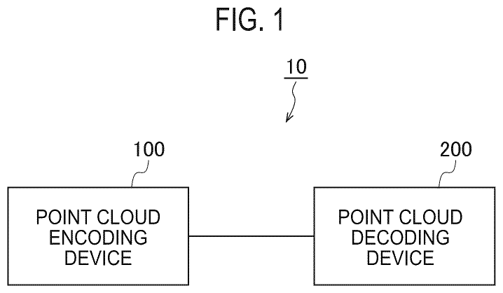

Hereinafter, a point cloud processing system 10 according to a first embodiment of the present invention will be described with reference to FIGS. 1 to 24. FIG. 1 is a diagram illustrating the point cloud processing system 10 according to the present embodiment.

As illustrated in FIG. 1, the point cloud processing system 10 includes a point cloud encoding device 100 and a point cloud decoding device 200.

The point cloud encoding device 100 is configured to generate encoded data (bit stream) by encoding an input point cloud signal. The point cloud decoding device 200 is configured to generate an output point cloud signal by decoding the bit stream.

Note that the input point cloud signal and the output point cloud signal include position information and attribute information of each point in a point cloud. The attribute information is, for example, color information or a reflection ratio of each point.

Here, such a bit stream may be transmitted from the point cloud encoding device 100 to the point cloud decoding device 200 through a transmission path. Furthermore, the bit stream may be stored in a storage medium, and then provided from the point cloud encoding device 100 to the point cloud decoding device 200.

### (Point Cloud Decoding Device 200)

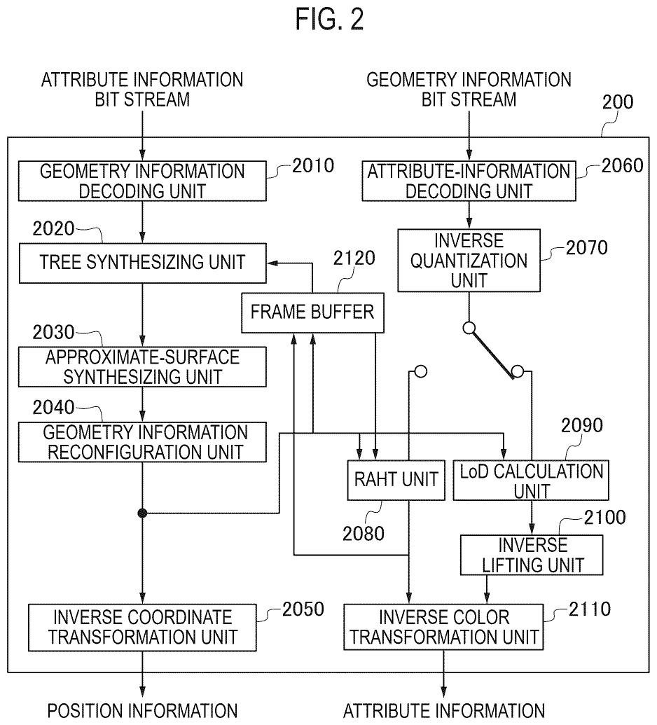

Hereinafter, the point cloud decoding device 200 according to the present embodiment will be described with reference to FIG. 2. FIG. 2 is a diagram illustrating an example of functional blocks of the point cloud decoding device 200 according to the present embodiment.

As illustrated in FIG. 2, the point cloud decoding device 200 includes a geometry information decoding unit 2010, a tree synthesizing unit 2020, an approximate-surface synthesizing unit 2030, a geometry information reconfiguration unit 2040, an inverse coordinate transformation unit 2050, an attribute-information decoding unit 2060, an inverse quantization unit 2070, a region adaptive hierarchical transform (RAHT) unit 2080, a level-of-detail (LoD) calculation unit 2090, an inverse lifting unit 2100, an inverse color transformation unit 2110, and a frame buffer 2120.

The geometry information decoding unit 2010 is configured to use, as input, a bit stream about geometry information (geometry information bit stream) among bit streams output from the point cloud encoding device 100, and to decode syntax.

Decoding processing is, for example, context-adaptive binary arithmetic decoding processing. Here, for example, the syntax includes control data (flags and parameters) for controlling the decoding processing of the position information.

The tree synthesizing unit 2020 is configured to use, as input, the control data, which has been decoded by the geometry information decoding unit 2010, and an occupancy code indicating on which node in a tree described later a point cloud is present, and to generate tree information indicating in which region in a decoding target space points are present.

Note that the tree synthesizing unit 2020 may be configured to perform decoding processing of an occupancy code.

The present process can generate the tree information by recursively repeating processing of partitioning the decoding target space into cuboids, determining whether or not a point is present in each cuboid by referring to the occupancy code, dividing the cuboid in which the point is present into a plurality of cuboids, and referencing the occupancy code.

Here, inter prediction may be used in decoding the occupancy code.

In the present embodiment, it is possible to use a method called “octree” in which octree division is recursively carried out with the above-described cuboids always as cubes, and a method called “QtBt” in which quadtree division and binary tree division are carried out in addition to octree division. Whether or not “QtBt” is to be used is transmitted as the control data from the point cloud encoding device 100 side.

Alternatively, the tree synthesizing unit 2020 is configured to, when the control data designates use of predictive geometry coding, decode the coordinates of each point based on an arbitrary tree configuration determined by the point cloud encoding device 100.

The approximate-surface synthesizing unit 2030 is configured to generate approximate-surface information using the tree information generated by the tree synthesizing unit 2020, and decode a point cloud based on this approximate-surface information.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

More specifically, the approximate-surface synthesizing unit 2030 can generate the approximate-surface information and decode the point cloud by, for example, a method called “Trisoup”. A specific “Trisoup” processing example will be described later. In addition, when decoding a sparse point cloud acquired by Lidar or the like, the present processing can be omitted.

The geometry information reconfiguration unit 2040 is configured to reconfigure the geometry information (position information on the coordinate system assumed by the decoding processing) of each point of decoding target point cloud data based on the tree information generated by the tree synthesizing unit 2020 and the approximate-surface information generated by the approximate-surface synthesizing unit 2030.

The inverse coordinate transformation unit 2050 is configured to use, as input, the geometry information reconfigured by the geometry information reconfiguration unit 2040, to transform the coordinate system assumed by the decoding processing into a coordinate system of the output point cloud signal, and to output the position information.

The frame buffer 2120 is configured to use, as input, the geometry information reconfigured by the geometry information reconfiguration unit 2040 to store as a reference frame. The stored reference frame is read from the frame buffer 2130 and used as a reference frame in a case where the tree synthesizing unit 2020 performs inter prediction on temporally different frames.

Here, which time reference frame is used for each frame may be determined based on, for example, control data transmitted as a bit stream from the point cloud encoding device 100.

The attribute-information decoding unit 2060 is configured to use, as input, a bit stream (attribute-information bit stream) about the attribute information among the bit streams output from the point cloud encoding device 100, and to decode syntax.

The decoding processing is, for example, context-adaptive binary arithmetic decoding processing. Here, for example, the syntax includes control data (flags and parameters) for controlling the decoding processing of the attribute information.

Furthermore, the attribute-information decoding unit 2060 is configured to decode quantized residual information from the decoded syntax.

The inverse quantization unit 2070 is configured to perform an inverse quantization process based on the quantized residual information decoded by the attribute-information decoding unit 2060 and quantization parameters that are one of items of the control data decoded by the attribute-information decoding unit 2060, and to generate inverse-quantized residual information.

The inverse-quantized residual information is output to one of the RAHT unit 2080 and the LoD calculation unit 2090 according to a feature of the decoding target point cloud. To which one of the RAHT unit 2080 and the LoD calculation unit 2090 the inverse-quantized residual information is output is designated by the control data decoded by the attribute-information decoding unit 2060.

The RAHT unit 2080 is configured to use, as input, the inverse-quantized residual information generated by the inverse quantization unit 2070, and the geometry information generated by the geometry information reconfiguration unit 2040, and to decode the attribute information of each point by using a type of Haar transformation (that is inverse Haar transformation in the decoding processing) called Region Adaptive Hierarchical Transform (RAHT). As specific processes of the RAHT, for example, the method described in Non Patent Literature 1 can be used.

The LoD calculation unit 2090 is configured to use, as input, the geometry information generated by the geometry information reconfiguration unit 2040, and to generate a Level of Detail (LoD).

The LoD is information for defining a reference relationship (a point that refers to and a point to be referred to) for implementing predictive coding such as encoding or decoding of a prediction residual by predicting attribute information of a certain point from attribute information of another certain point.

In other words, the LoD is information defining a hierarchical structure in which each point included in the geometry information is classified into a plurality of levels, and for a point belonging to a lower level, an attribute is encoded or decoded using attribute information of a point belonging to an upper level.

As a specific LoD determination method, for example, the method described in Non Patent Literature 1 described above may be used.

The inverse lifting unit 2100 is configured to decode the attribute information of each point based on a hierarchical structure defined by the LoD using the LoD generated by the LoD calculation unit 2090 and the inverse-quantized residual information generated by the inverse quantization unit 2070. As specific processes of inverse lifting, for example, the method described in Non Patent Literature 1 described above can be used.

The inverse color transformation unit 2110 is configured to, when the attribute information of the decoding target is the color information, and color transformation has been carried out on the point cloud encoding device 100 side, perform an inverse color transformation process on the attribute information output from the RAHT unit 2080 or the inverse lifting unit 2100. Whether or not to perform the inverse color transformation process is determined according to the control data decoded by the attribute-information decoding unit 2060.

The point cloud decoding device 200 is configured to decode and output the attribute information of each point in the point cloud by the above processes.

### (Geometry Information Decoding Unit 2010)

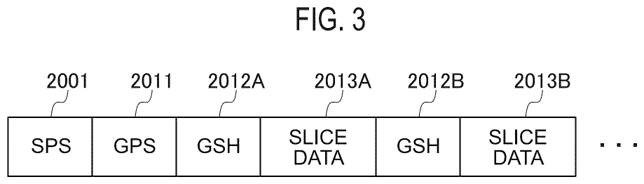

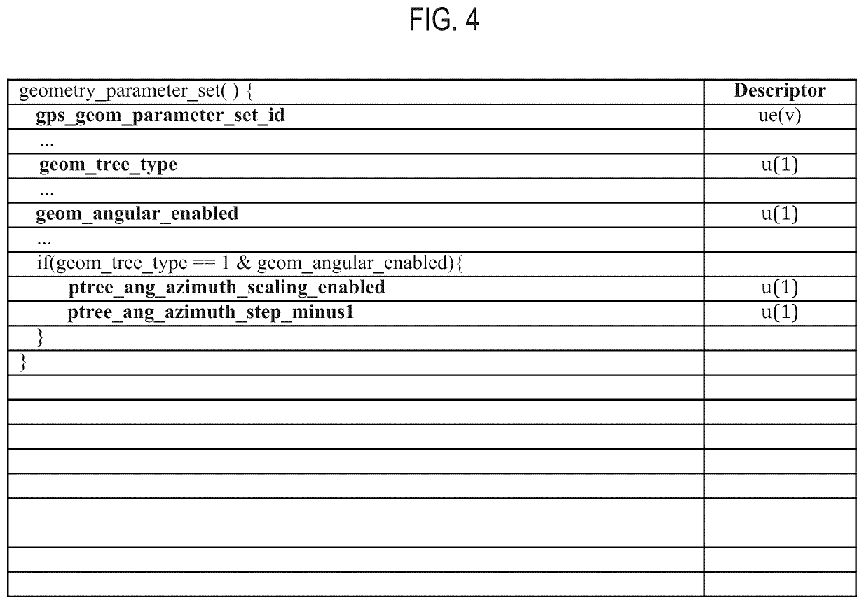

The control data decoded by the geometry information decoding unit 2010 will be described below with reference to FIGS. 3 to 4.

FIG. 3 illustrates an example of a configuration of encoded data (bit stream) received by the geometry information decoding unit 2010.

First, the bit stream may include a GPS 2011. The GPS 2011 is also called a geometry parameter set, and is a set of control data related to decoding of the geometry information. A specific example thereof will be described later. Each GPS 2011 includes at least GPS id information for identifying the individual GPSs 2011 in a case where there are the plurality of GPSs 2011.

Second, the bit stream may include a GSH 2012A/2012B. The GSH 2012A/2012B is also called a geometry slice header or a geometry data unit header, and is a set of control data corresponding to a slice to be described later. Hereinafter, a description will be given using the term “slice”, but the slice may be read as a data unit. A specific example thereof will be described later. The GSH 2012A/2012B includes at least GPS id information for designating the GPS 2011 associated with each of the GSH 2012A/2012B.

Third, the bit stream may include slice data 2013A/2013B in addition to the GSH 2012A/2012B. The slice data 2013A/2013B includes data obtained by encoding the geometry information. An example of the slice data 2013A/2013B includes the occupancy code to be described later.

As described above, the bit stream is configured such that each slice data 2013A/2013B is associated with the GSH 2012A/2012B and the GPS 2011 one by one.

As described above, since which GPS 2011 is referred to in the GSH 2012A/2012B is designated by the GPS id information, the GPS 2011 common to a plurality of items of slice data 2013A/2013B can be used.

In other words, the GPS 2011 does not necessarily need to be transmitted for each slice. For example, the bit stream may be configured such that the GPS 2011 is not encoded immediately before the GSH 2012B and the slice data 2013B as in FIG. 3.

Note that the configuration in FIG. 3 is merely an example. As long as each slice data 2013A/2013B is configured to be associated with the GSH 2012A/2012B and the GPS 2011, an element other than those described above may be added as a constituent element of the bit stream.

For example, as illustrated in FIG. 3, the bit stream may include a sequence parameter set (SPS) 2001. Similarly, the bit stream may have a configuration different from that in FIG. 3 at the time of transmission. Furthermore, the bit stream may be synthesized with a bit stream decoded by the attribute-information decoding unit 2060 described later and transmitted as a single bit stream.

FIG. 4 illustrates an example of a syntax configuration of the GPS 2011.

Note that syntax names described below are merely examples. The syntax names may vary as long as the functions of the syntaxes described below are similar.

The GPS 2011 may include GPS id information (gps_geom_parameter_set_id) for identifying each GPS 2011.

Note that a Descriptor column in FIG. 4 indicates how each syntax is encoded. ue(v) means an unsigned 0-order exponential-Golomb code, and u(1) means a 1-bit flag.

The GPS 2011 may include a flag (geom_tree_type) for controlling a tree type in the tree synthesizing unit 2020.

For example, when the value of geom_tree_type is “1”, it may be defined that predictive geometry coding is used, and when the value of geom_tree_type is “0”, it may be defined that octree is used.

The GPS 2011 may include a flag (geom_angular_enabled) for controlling whether or not to perform processing in an angular mode in the tree synthesizing unit 2020.

For example, when the value of geom_angular_enabled is “1”, it may be defined that predictive geometry coding is performed in the angular mode, and when the value of geom_angular_enabled is “0”, it may be defined that predictive geometry coding is not performed in the angular mode.

The GPS 2011 may include a flag (ptree_ang_azimuth_scaling_enabled) for controlling whether or not an adaptive azimuth angle quantization mode is activated in the angular mode by the tree synthesizing unit 2020. The adaptive azimuth angle quantization mode is a mode for performing adaptive quantization of an azimuth angle according to a radius.

For example, when the value of ptree_ang_azimuth_scaling_enabled is “1”, it may be defined that the adaptive azimuth angle quantization according to the radius is performed, and when the value of ptree_ang_azimuth_scaling_enabled is “0”, it may be defined that the adaptive azimuth angle quantization according to the radius is not performed.

Furthermore, in the calculation (selection) of the predictor in the angular mode, the flag may be used as a flag for controlling whether to use the predictor list.

For example, when the value of ptree_azimuth_scaling_enabled is “1”, it may be defined that the predictor list is used in the calculation of such a predictor, and when the value of ptree_ang_azimuth_scaling_enabled is “0”, it may be defined that the predictor list is not used in the calculation of such a predictor.

The GPS 2011 may include a value (ptree_ang_azimuth_step_minus1) related to a rotation speed of a laser used to calculate a predicted value of an azimuth angle in the angular mode by the tree synthesizing unit 2020.

### (Tree Synthesizing Unit 2020)

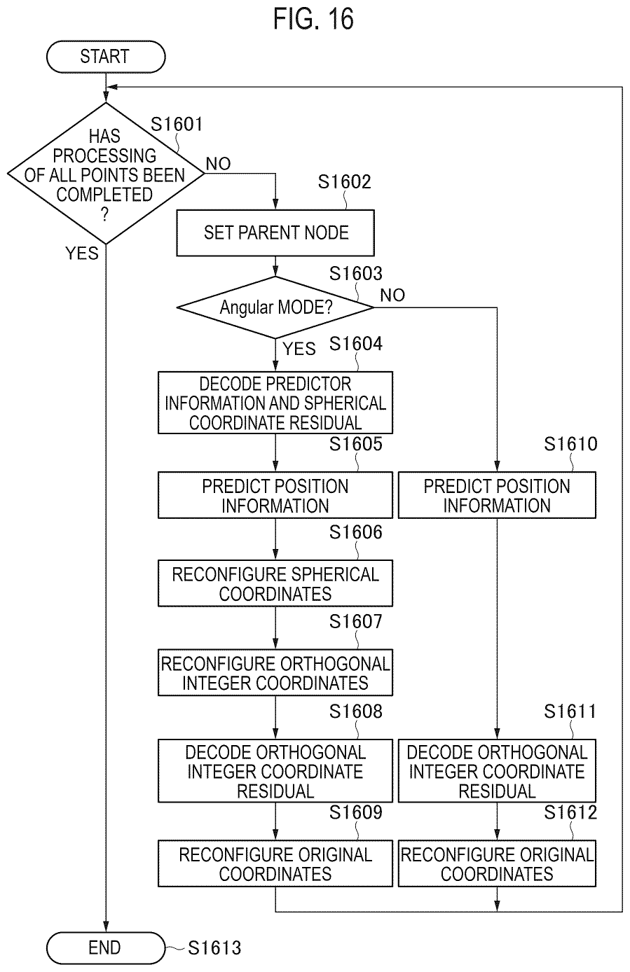

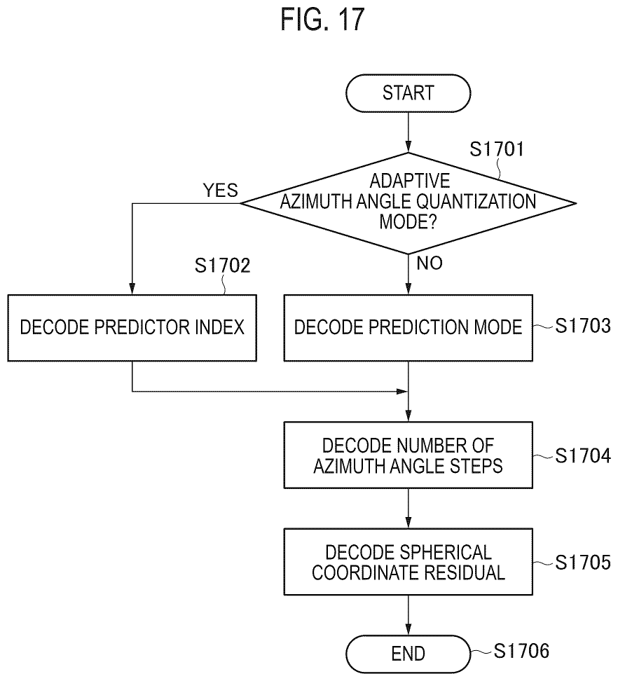

Hereinafter, an example of the operation of the tree synthesizing unit 2020 will be described with reference to FIGS. 16 and 17.

FIG. 16 is a flowchart illustrating an example of processing in the tree synthesizing unit 2020. Note that an example in a case where trees are synthesized using “predictive geometry coding” will be described below.

The predictive geometry coding is also called predictive tree. The predictive geometry coding is a means for decoding position information predicted based on an arbitrary tree structure determined on a point cloud encoding device 100 side and a residual of position information of the point cloud data, and for decoding the position information of the point cloud data by adding both pieces of the position information.

As illustrated in FIG. 16, in Step S1601, the tree synthesizing unit 2020 determines whether or not decoding of the position information of all the pieces of point cloud data included in the slice has been completed.

In the present processing, for example, information indicating the number of pieces of point cloud data included in the slice is transmitted to the GSH, and the number of pieces of point cloud data is compared with the number of pieces of already processed data, so that it is possible to determine whether or not the processing of all the points has been completed.

In a case where the decoding of the position information of all the pieces of point cloud data has been completed, the present operation proceeds to Step S1613, and the processing is terminated. In a case where the decoding of the position information of all the pieces of point cloud data has not been completed, the present operation proceeds to Step S1602.

In Step S1602, the tree synthesizing unit 2020 sets a parent node of a decoding target node (processing target node) of the point cloud data.

For example, the tree synthesizing unit 2020 decodes the number of child nodes for each decoding target node, and stores the index of the decoding target node by the number of child nodes.

Then, in a case where the decoding target node is processed after a certain node, the tree synthesizing unit 2020 may refer to an array of the indexes of the node, acquire one index stored at the end of the array, and set a node of the acquired index as a parent node of the decoding target node.

After the setting of the parent node is completed, the present operation proceeds to Step S1603.

In Step S1603, the tree synthesizing unit 2020 determines whether or not to perform the processing in the angular mode.

For example, the tree synthesizing unit 2020 can determine whether or not to perform the processing in the angular mode by referring to the value of geom_angular_enabled described above.

In the case of performing the processing in the angular mode, the present operation proceeds to Step S1604, and in the case of not performing the processing in the angular mode, the present operation proceeds to Step S1610.

In Step S1604, the tree synthesizing unit 2020 decodes predictor information and a spherical coordinate residual used in Step S1605. Here, the spherical coordinate residual indicates residuals of the radius, the azimuth angle, or a laser ID. When the decoding is completed, the present operation proceeds to Step S1605.

In Step S1605, the tree synthesizing unit 2020 predicts the position information on the basis of the predictor information decoded in Step S1604. Here, the predictor information is a predictor index or a prediction mode.

In such processing, the tree synthesizing unit 2020 first determines the type of the predictor to be used for prediction.

For example, the tree synthesizing unit 2020 may determine whether or not to perform the processing in the adaptive azimuth angle quantization mode based on the value of ptree_ang_azimuth_scaling_enabled, and determine the type of the predictor to be used based on the determination result.

For example, in the adaptive azimuth angle quantization mode, the tree synthesizing unit 2020 may select a predictor to be used based on the decoded prediction mode from among the plurality of predictors calculated using the tree structure.

Alternatively, in a case where the processing is performed in the adaptive azimuth angle quantization mode, the tree synthesizing unit 2020 may hold the position information of decoded nodes in the list as predictors, refer to a predictor allocated to a decoded predictor index from the list, and select the predictor as the type of predictor to be used.

Once the type of the predictor is determined, the tree synthesizing unit 2020 sets the predictor as the predicted value of the position information.

After the prediction of the position information is completed, the present operation proceeds to Step S1606.

In Step S1606, the tree synthesizing unit 2020 reconfigures spherical coordinates. In such processing, the tree synthesizing unit 2020 reconfigures the spherical coordinates by adding the decoded spherical coordinate residual and the predictor.

After the reconfiguration is completed, the present operation proceeds to Step S1607.

In Step S1607, the tree synthesizing unit 2020 reconfigures orthogonal integer coordinates. In such processing, the tree synthesizing unit 2020 can convert the spherical coordinates into the orthogonal integer coordinates based on the reconfigured spherical coordinates. As a specific method, for example, the method described in Non Patent Literature 1 can be implemented.

After the reconfiguration of the orthogonal integer coordinates is completed, the present operation proceeds to Step S1608.

In Step S1608, the tree synthesizing unit 2020 decodes an orthogonal integer coordinate residual.

After the decoding of the orthogonal integer coordinate residual is completed, the present operation proceeds to Step S1609.

In Step S1609, the tree synthesizing unit 2020 reconfigures the original coordinates. In such processing, the tree synthesizing unit 2020 reconfigures the original coordinates by adding the decoded orthogonal integer coordinate residual and the reconfigured orthogonal integer coordinates.

After the reconfiguration of the original coordinates is completed, the present operation returns to Step S1601.

In Step S1610, the tree synthesizing unit 2020 predicts the position information. Specifically, the tree synthesizing unit 2020 selects the predictor, and sets the predictor as the predicted value of the position information.

For example, the tree synthesizing unit 2020 may select, based on the decoded predictor mode, the predictor from among the plurality of predictors calculated based on the tree structure.

After the prediction of the position information is completed, the present operation proceeds to Step S1611.

In Step S1611, the tree synthesizing unit 2020 decodes an orthogonal integer coordinate residual.

After the decoding of the orthogonal integer coordinate residual is completed, the present operation proceeds to Step S1612.

In Step S1612, the tree synthesizing unit 2020 reconfigures the original coordinates. In such processing, the tree synthesizing unit 2020 reconfigures the original coordinates by adding the orthogonal integer coordinate residual decoded in Step S1611 and the position information predicted in Step S1610.

After the reconfiguration of the original coordinates is completed, the present operation returns to Step S1601.

FIG. 17 is a flowchart illustrating an example of processing of decoding the predictor information and the spherical coordinate residual in Step S1604.

As illustrated in FIG. 17, in Step S1701, the tree synthesizing unit 2020 determines whether or not the adaptive azimuth angle quantization mode has been activated based on the value of ptree_ang_azimuth_scaling_enabled.

In a case where the adaptive azimuth angle quantization mode has been activated, the present operation proceeds to Step S1702. On the other hand, in a case where the adaptive azimuth angle quantization mode has not been activated, the present operation proceeds to Step S1703.

In Step S1702, the tree synthesizing unit 2020 decodes the predictor index. After the predictor index decoding is completed, the present operation proceeds to Step S1704.

In Step S1703, the tree synthesizing unit 2020 decodes the prediction mode. After the decoding of the prediction mode is completed, the present operation proceeds to Step S1704.

In Step S1704, the tree synthesizing unit 2020 decodes the number of azimuth angle steps. After the decoding of the number of azimuth angle steps is completed, the present operation proceeds to Step S1705.

In Step S1705, the tree synthesizing unit 2020 decodes the spherical coordinate residual. The tree synthesizing unit 2020 may perform such decoding using the method described in Non Patent Literature 2. After the decoding is completed, the present operation proceeds to Step S1706, and the processing ends.

### (Attribute-Information Decoding Unit 2060)

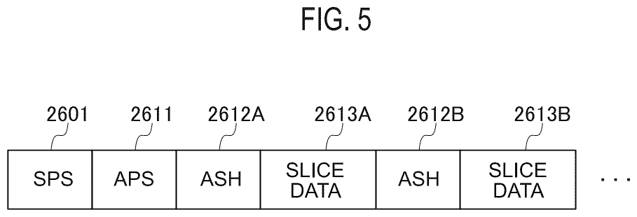

Control data decoded by the attribute-information decoding unit 2060 will be described below with reference to FIGS. 5, 6, and 24.

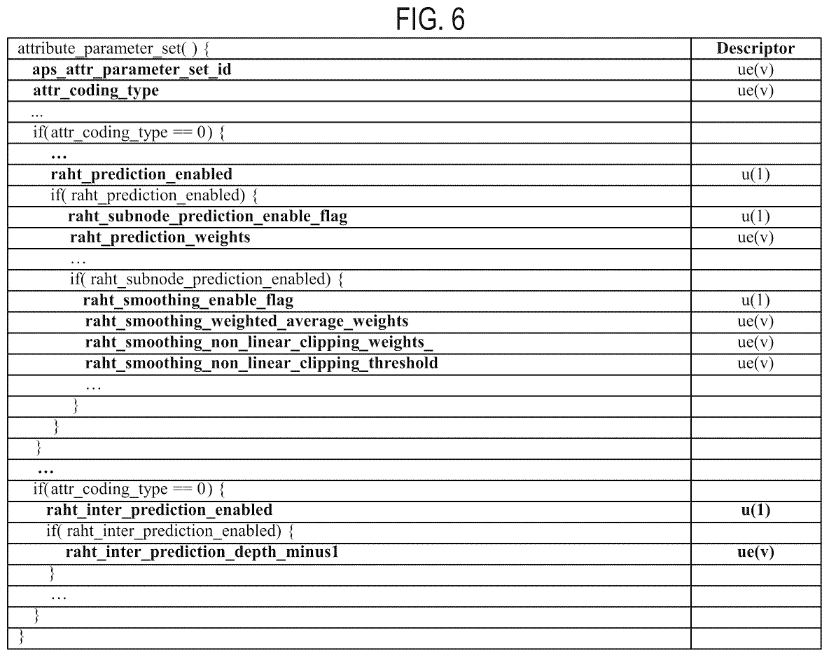

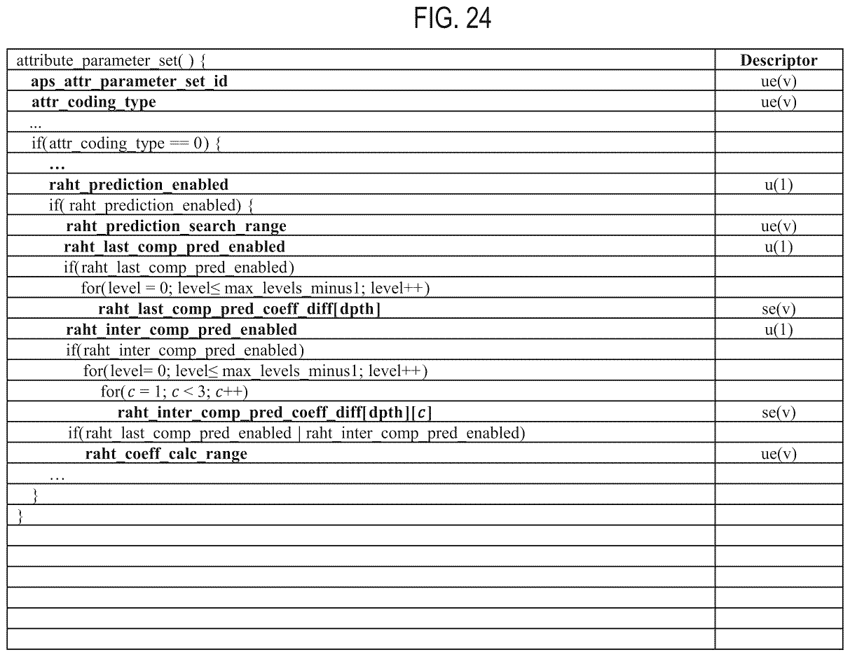

FIG. 5 is an example of a configuration of encoded data (bit stream) received by the attribute-information decoding unit 2060, and FIGS. 6 and 24 are examples of a syntax configuration of the APS 2611 illustrated in FIG. 5.

Note that syntax names described below are merely examples. The syntax names may vary as long as the functions of the syntaxes described below are similar.

The APS 2611 may include APS id information (aps_geom_parameter_set_id) for identifying each APS 2611.

Note that the Descriptor field in FIG. 6 indicates how each syntax is encoded, se(v) indicates a signed 0-order exponential Golomb code, ue(v) indicates an unsigned 0-order exponential Golomb code, and u(1) indicates a 1-bit flag.

The APS 2611 may include a flag (attr_coding_type) for controlling which one of the RAHT unit 2080 and the LoD calculation unit 2090 the inverse quantization unit 2070 outputs inversely quantized residual information to.

For example, when the value of attr_coding_type is “1”, it may be defined that the inversely quantized residual information is output to the LoD calculation unit 2090, and when the value of attr_coding_type is “0”, it may be defined that the inversely quantized residual information is output to the RAHT unit 2080.

The APS 2611 may include a flag (raht_prediction_enabled) for controlling whether the RAHT unit 2080 predicts attribute information.

For example, when the value of raht_prediction_enabled is “1”, it may be defined that attribute information is predicted, and when the value of raht_prediction_enabled is “0”, it may be defined that attribute information is not predicted.

The APS 2611 may include a flag (raht_subnode_prediction_enable_flag) for controlling whether the RAHT unit 2080 uses a subnode to predict the attribute information.

For example, when the value of raht_subnode_prediction_enable_flag is “1”, it may be defined that a subnode is used to predict attribute information, and when the value of raht_subnode_prediction_enable_flag is “0”, it may be defined that a subnode is not used to predict attribute information.

The APS 2611 may include a weight parameter (raht_prediction_weights) when the RAHT unit 2080 performs intra prediction of attribute information.

For example, the value of raht_prediction_weights may be defined according to how the decoding target node is adjacent to the adjacent node used for intra prediction.

The APS 2611 may include a flag (raht_smoothing_enable_flag) for controlling whether the RAHT unit 2080 performs smoothing after performing intra prediction of attribute information.

For example, when the value of raht_smoothing_enable_flag is “1”, it may be defined that smoothing is performed after prediction of attribute information, and when the value of raht_smoothing_enable_flag is “0”, it may be defined that smoothing is not performed.

The APS 2611 may include a weight parameter (raht_smoothing_weighted_average_weights) for the RAHT unit 2080 to perform smoothing by weighted averaging after performing intra prediction of attribute information.

For example, up to eight such weight parameters may be defined according to how the decoding target node is adjacent to each subnode of the same parent node of the decoding target node.

The APS 2611 may include a weight parameter (raht_smoothing_clipping_weights) for the RAHT unit 2080 to perform smoothing by clipping after performing intra prediction of attribute information.

For example, up to eight such weight parameters may be defined according to how the decoding target node is adjacent to each subnode of the same parent node of the decoding target node.

The APS 2611 may include a threshold (raht_smoothing_clipping_threshold) for the RAHT unit 2080 to perform smoothing by clipping after performing intra prediction of attribute information.

The APS 2611 may include a flag (raht_inter_prediction_enabled) for controlling whether the RAHT unit 2080 performs inter prediction of attribute information.

For example, when the value of raht_inter_prediction_enabled is “1”, it may be defined that attribute information is predicted, and when the value of raht_inter_prediction_enabled is “0”, it may be defined that attribute information is not predicted.

The APS 2611 may include a value (raht_inter_prediction_depth_minus1) indicating a hierarchy in which the inter prediction of attribute information performed by the RAHT unit 2080 is enabled.

For example, when raht_inter_prediction_depth_minus1 is “N−1”, the inter prediction may be enabled in up to the higher N hierarchies of the octree structure.

When the attribute information is predicted (for example, when the value of raht_prediction_enabled is “1”), the APS2611 may additionally include the following syntax as illustrated in FIG. 24.

The APS2611 may include syntax (raht_prediction_search_range) indicating a maximum search range at the time of searching for a higher-level hierarchy node of the RAHT.

The APS2611 may include a flag (raht_last_comp_pred_enabled) indicating whether or not the Cr signal is predicted from the Cb signal. For example, it may be defined that the Cr signal is predicted from the Cb signal when the value of such a flag is “1”, and the Cr signal is not predicted from the Cb signal when the value of such a flag is “0”.

When predicting the Cr signal from the Cb signal, the APS2611 may additionally include syntax (raht_last_comp_pred_coeff_diff[dpth]) indicating a prediction coefficient value.

The attribute information decoding unit 2060 may decode such prediction coefficients as different values for each RAHT hierarchy. Further, the attribute information decoding unit 2060 may decode the value of the prediction coefficient as a difference value from the (decoded) coefficient value of the higher-level hierarchy instead of decoding the value of the predicted coefficient as it is.

The APS2611 may include a flag (raht_inter_comp_pred_enabled) indicating whether or not a chroma signal (Cb signal and Cr signal) is predicted from a luminance signal. For example, it may be defined that the chroma signal (Cb signal and Cr signal) is predicted from the luminance signal when the value of such a flag is “1”, and the chroma signal (Cb signal and Cr signal) is not predicted from the luminance signal when the value of such a flag is “0”.

When predicting the chroma signal (Cb signal and Cr signal) from the luminance signal, the APS2611 may additionally include syntax (raht_inter_comp_pred_coeff_diff [dpth]) indicating a prediction coefficient value.

The attribute information decoding unit 2060 may decode different values of the prediction coefficient for each RAHT hierarchy. Furthermore, the attribute information decoding unit 2060 may decode different values for each prediction target component (Cb signal and Cr signal) for the prediction coefficient. Further, the attribute information decoding unit 2060 may decode the value of the prediction coefficient as a difference value from the (decoded) coefficient value of the higher-level hierarchy instead of decoding the value of the predicted coefficient as it is.

In a case where the Cr signal is predicted from the Cb signal or in a case where the chroma signal (the Cb signal and the Cr signal) is predicted from the luminance signal, the APS2611 may additionally include syntax (raht_coeff_calc_range) indicating a reference range when the prediction coefficient is calculated on the point cloud decoding device 200 side.

### (RAHT Unit 2080)

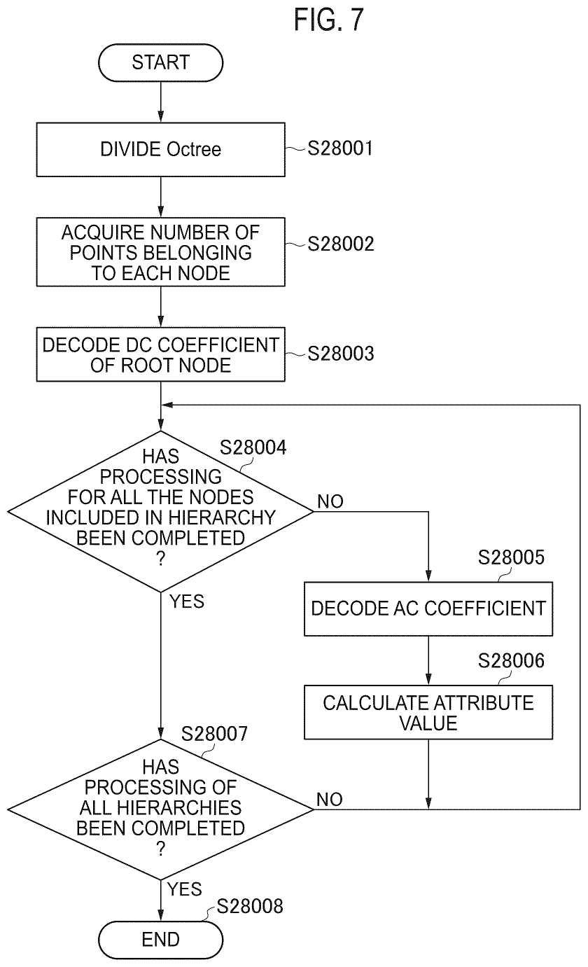

An example of processing of the RAHT unit 2080 will be described with reference to FIGS. 7 to 15.

FIG. 7 is a flowchart illustrating an example of processing of the RAHT unit 2080.

As illustrated in FIG. 7, in Step S28001, the RAHT unit 2080 recursively divides a node into eight tree segments until the node has a predetermined size, using a technique called octree. After the division is completed, the present operation proceeds to Step S28002.

In Step S28002, for each node divided by the octree, the RAHT unit 2080 counts the total number of points belonging to the hierarchy lower than the node.

Specifically, the RAHT unit 2080 sequentially scans nodes in a certain hierarchy and records the number of points belonging to each node. Next, the RAHT unit 2080 adds up the numbers of points recorded in the child nodes of each of the nodes of the one level-higher hierarchy to calculate the number of points belonging to each node.

The RAHT unit 2080 repeats the above scanning in order from the lowest-level hierarchy to the highest-level hierarchy. The acquired total number of points is used as a weight for inverse transform of RAHT in Step S28005 to be described later. After the calculation is completed, the present operation proceeds to Step S28003.

In Step S28003, the RAHT unit 2080 decodes the DC coefficient of the node belonging to the highest-level hierarchy of the octree. Alternatively, the RAHT unit 2080 may calculate the DC coefficient by predicting the DC coefficient using intra prediction, and decoding and adding prediction residuals of the DC coefficient.

After the decoding of the DC coefficient is completed, the RAHT unit 2080 calculates an attribute value Aroot of the root node by using the total number wᵣₒₒₜ of points belonging to the root node, which is acquired in Step S28002, and the decoded DC coefficient DCroot according to the following formula.

$$[ Math . 1 ]$$

$${A}_{root} = {DC}_{root} \sqrt{{W}_{root}}$$

After the calculation is completed, the present operation proceeds to Step S28004.

In Step S28004, the RAHT unit 2080 determines whether the decoding of the attribute information has been completed for all the nodes included in the hierarchy.

When the decoding of the attribute information has not been completed for all the nodes included in the hierarchy, the present operation proceeds to Step S28005, and when the decoding of the attribute information has been completed for all the nodes included in the hierarchy, the present operation proceeds to Step S28007.

In Step S28005, the RAHT unit 2080 decodes the AC coefficient. This will be described in detail later. When the decoding of the AC coefficient is completed, the present operation proceeds to Step S28006.

In Step S28006, the RAHT unit 2080 calculates an attribute value by using inverse transform of RAHT based on the counted total number of points belonging to the hierarchy lower than each node, the decoded AC coefficient, and the DC coefficient calculated from the node of the higher-level hierarchy by the method to be described later.

Here, the inverse transform of RAHT is performed in units of eight nodes (2×2×2) divided into eight tree segments by the octree.

Specifically, attribute values A₁, A₂, . . . , and Aₖ are obtained according to the following formula (1) using the DC coefficients DC of the nodes holding k subnodes, the AC coefficients AC₁, AC₂, . . . , and ACₖ₋₁, and the total numbers w=w₁, w₂, . . . , and wₖ of points belonging to the hierarchy lower than each subnode.

$$[ Math . 2 ]$$

$$[ \begin{matrix}{A}_{1} / \sqrt{{w}_{1}} \\ ⋮ \\ {A}_{k} / \sqrt{{w}_{k}}\end{matrix} ] = {T ( w )}^{- 1} [ \begin{matrix}DC \\ {AC}_{1} \\ ⋮ \\ {AC}_{k ‐ 1}\end{matrix} ] \qquad ( 1 )$$

Here, T(w)⁻¹ is a matrix used for inverse transform of RAHT, and can be generated, for example, by the method described in Non Patent Literature 1.

It is assumed that such transform processing is repeatedly performed in order from a node of a higher-level hierarchy to a node of a lower-level hierarchy, and

$$[ Math . 3 ]$$

$${A}_{1} / 1 \sqrt{{w}_{1}} , {A}_{2} / \sqrt{{w}_{2}} , … , {A}_{k} / \sqrt{{w}_{k}}$$

which is used as a DC coefficient in the inverse transform of RAHT for each subnode. After the transform processing is completed, the present operation proceeds to Step S28004.

In Step S28007, the RAHT unit 2080 determines whether the decoding has been completed for all the nodes in all the hierarchies.

When the decoding has not been completed for all the nodes in all the hierarchies, the present operation moves the processing target hierarchy to the one level-lower hierarchy, and proceeds to Step S28004. When the decoding has been completed for all the nodes in all the hierarchies, the present operation proceeds to Step S28008, and the processing ends.

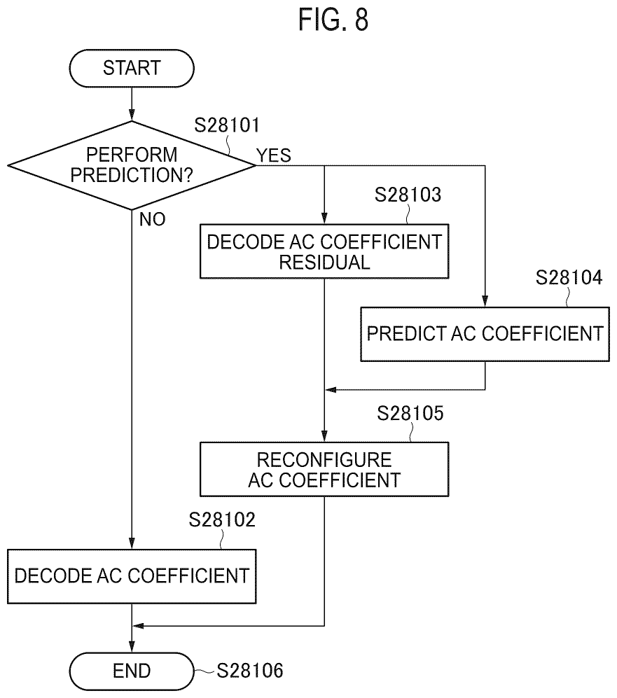

FIG. 8 is a flowchart illustrating an example of processing of Step S28004.

As illustrated in FIG. 8, in Step S28101, the RAHT unit 2080 determines whether to predict an AC coefficient. When making such a determination, the RAHT unit 2080 may refer to raht_prediction_enabled and use the value thereof.

The RAHT unit 2080 may decode the flag indicating whether to predict the AC coefficient in the current processing target node, and use the value of the flag.

Such a flag may be decoded for each node or may be decoded for each hierarchy. Such a flag may be decoded only when the value of raht_prediction_enabled is “1”, which is a value indicating that prediction is enabled. Such a flag may be included in slice data.

As a result of the determination, when the AC coefficient is not predicted, the present operation proceeds to Step S28102, and when the AC coefficient is predicted, the present operation proceeds to Steps S28103 and S28104.

In Step S28102, the RAHT unit 2080 decodes the AC coefficient. After the decoding is completed, the present operation proceeds to Step S28106, and the processing ends.

In Step S28103, the RAHT unit 2080 decodes the AC coefficient residual.

For example, the RAHT unit 2080 may perform inverse quantization processing on the quantized AC coefficient residual decoded from the bit stream on the basis of the quantization parameter decoded from the bit stream to calculate the AC coefficient residual after the inverse quantization. In such a case, the AC coefficient residual after the inverse quantization corresponds to the output (decoded AC coefficient residual) in Step S28103.

Alternatively, for example, the RAHT unit 2080 may directly use the quantized AC coefficient residual decoded from the bit stream as the output (decoded AC coefficient residual) in Step S28103.

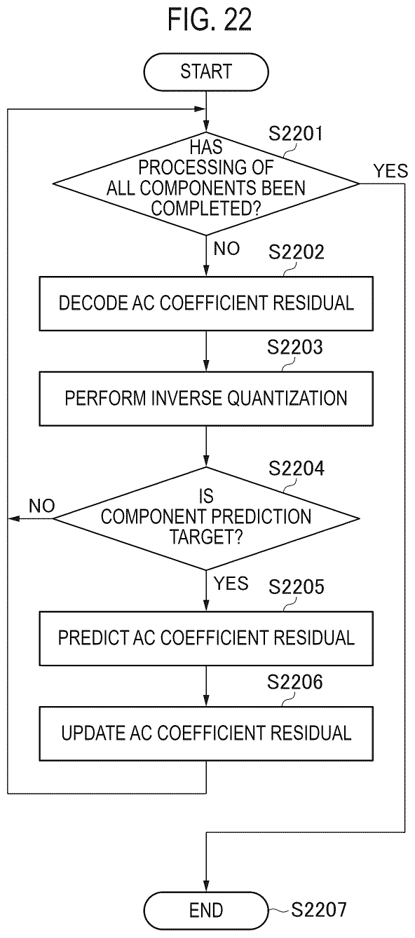

In addition, the RAHT unit 2080 may decode the AC coefficient residual by the method illustrated in FIG. 22.

FIG. 22 is a flowchart illustrating an example of processing of Step S28103. Note that FIG. 22 is a flowchart assuming a case where the attribute signal to be decoded has a plurality of components (for example, a luminance signal (Y signal), a chroma signal (Cb signal and Cr signal), and the like).

As illustrated in FIG. 22, in Step S2201, the RAHT unit 2080 determines whether decoding of the AC coefficient residuals of all the components in the AC coefficient is completed.

In a case where the decoding of the AC coefficient residuals of all the components is completed, the present operation proceeds to Step S2207 and ends the processing. Meanwhile, in a case where the decoding of the AC coefficient residuals of all the components is not completed, the present operation proceeds to Step S2202.

In Step S2202, the RAHT unit 2080 decodes the AC coefficient residual after quantization of the component of the AC coefficient from the bit stream.

Note that the RAHT unit 2080 may decode the quantized AC coefficient residual from the bit stream and store the AC coefficient residual in the memory prior to the processing of Step S2202, and read the AC coefficient residual stored in the memory in Step S2202. After the quantized AC coefficient residual is decoded as described above, the present operation proceeds to Step S2203.

In Step S2203, the RAHT unit 2080 performs inverse quantization processing on the quantized AC coefficient residual decoded in Step S2202 on the basis of the quantization parameter decoded from the bit stream, and calculates the AC coefficient residual after inverse quantization. After the above processing is completed, the present operation proceeds to Step S2204.

In Step S2204, the RAHT unit 2080 checks whether or not the component is a target of inter-component prediction.

The RAHT unit 2080 may determine whether or not the component is the target of the inter-component prediction on the basis of a value of a syntax element included in a header such as SPS, APS, or ASH.

For example, the RAHT unit 2080 may predict the chroma signal from the luminance signal. In such a case, the target of the inter-component prediction is the chroma signal (Cb signal and Cr signal).

In addition, the RAHT unit 2080 may perform the inter-component prediction between the chroma signals. For example, the RAHT unit 2080 may predict the Cr signal from the Cb signal. In such a case, the target of the inter-component prediction is the Cr signal.

Here, it is assumed that the Y signal, the Cb signal, and the Cr signal are decoded in this order. When performing the inter-component prediction, the RAHT unit 2080 can use only a signal that has been decoded before a signal to be predicted.

In a case where the component is not the inter-component prediction target, the present operation returns to Step S2201 and performs processing of the next component. Meanwhile, in a case where the component is the inter-component prediction target, the present operation proceeds to Step S2205.

In Step S2205, the RAHT unit 2080 performs inter-component prediction of the AC coefficient residual.

Hereinafter, a case where inter-component prediction of the Cb signal is performed from the luminance signal will be described as an example, but inter-component prediction of the Cr signal from the luminance signal and inter-component prediction of the Cr signal from the Cb signal are similarly possible.

Here, the AC coefficient residual of the luminance signal after inverse quantization calculated in Step S2203 is set to Y′. The predicted value Crp′ of the AC coefficient residual of the Cb signal can be calculated as, for example, the following formula.

$${Crp}^{′} = a \times {Y}^{′} + b$$

Here, a and b are prediction coefficients.

The RAHT unit 2080 may decode the prediction coefficient from a header such as SPS, APS, or ASH.

Alternatively, the RAHT unit 2080 may calculate the prediction coefficient from another already decoded AC coefficient residual. Specifically, for example, in the above-described formula, the RAHT unit 2080 may calculate and use an AC coefficient residual that minimizes the sum of squared errors in a case where the AC coefficient residual of the Cb signal after inverse quantization is predicted from the AC coefficient residual of the luminance signal after inverse quantization of another AC coefficient residual that has already been decoded.

The above-described processing can be analytically calculated by using the least squares method. At this time, the RAHT unit 2080 may use all the decoded AC coefficient residuals for calculation of the prediction coefficient.

Further, the RAHT unit 2080 may use only the N AC coefficient residuals most recently decoded with reference to the AC coefficient residuals for calculation of the prediction coefficient. Here, the RAHT unit 2080 may determine the number of N before decoding, or may decode the value of N from a header such as SPS, APS, or ASH. For example, the RAHT unit 2080 may use the value of raht_coeff_calc_range as N.

In addition, the RAHT unit 2080 may use a weighted least squares method instead of a simple least squares method. Specifically, the RAHT unit 2080 may perform the weighting described above on the basis of an absolute value of a difference between the inversely quantized AC coefficient residual value Y′ of the Y signal of the AC coefficient residual and the inversely quantized AC coefficient residual of the Y signal of the already decoded AC coefficient residual, or a square value of the difference. At this time, the RAHT unit 2080 may define such that the weight becomes heavier (the absolute value of the weight coefficient becomes larger) as the difference becomes smaller.

After the predicted value Crp′ of the AC coefficient residual is obtained as described above, the present operation proceeds to the next Step S2206.

In Step S2206, the RAHT unit 2080 updates the AC coefficient residual. Specifically, the RAHT unit 2080 updates the AC coefficient residual Cb′ after inverse quantization of the Cb signal decoded in Step S2203 as follows using the predicted value Crp′.

$${Cb}^{′} = {Cb}^{′} + {Crp}^{′}$$

After the update is completed, the present operation proceeds to Step S2201 to perform processing of the next component.

As described above, after the decoding is completed, the present operation proceeds to Step S28105.

In Step S28104, the RAHT unit 2080 predicts the AC coefficient. For the prediction of the AC coefficient, inter prediction or intra prediction may be used.

The RAHT unit 2080 may first predict an attribute value and then calculate a predicted value of the AC coefficient by RAHT. This will be described in detail later. After the prediction of the AC coefficient is completed, the present operation proceeds to Step S28105.

In Step S28105, the RAHT unit 2080 adds the decoded AC coefficient residual and the predicted AC coefficient to reconfigure the AC coefficient. After the reconfiguration is completed, the present operation proceeds to Step S28106, and the processing ends.

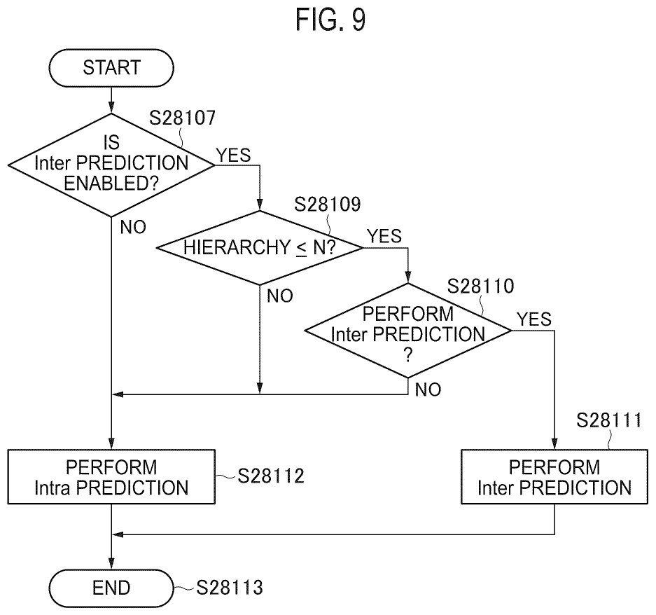

FIG. 9 is a flowchart illustrating an example of processing of Step S28104.

As illustrated in FIG. 9, in Step S28107, the RAHT unit 2080 determines whether inter prediction is enabled. For the determination, the RAHT unit 2080 may refer to raht_inter_prediction_enabled and use the value thereof. As a result of the determination, when inter prediction is enabled, the present operation proceeds to Step S28109, and when inter prediction is disabled, the present operation proceeds to Step S28112.

In Step S28109, the RAHT unit 2080 determines whether the depth of the hierarchy including the processing target node is equal to or less than a threshold. The RAHT unit 2080 may refer to raht_inter_prediction_depth_minus1 as the threshold and use the value thereof.

As a result of the determination, when the depth is equal to or less than the threshold, the present operation proceeds to Step S28110, and when the depth is larger than the threshold, the present operation proceeds to Step S28112.

In Step S28110, the RAHT unit 2080 determines whether to perform inter prediction on the AC coefficient of the processing target node.

For the determination, the RAHT unit 2080 may check whether inter prediction is executable, perform inter prediction when the inter prediction is executable, and not perform inter prediction when the inter prediction is not executable. This will be described in detail later.

For the determination, the RAHT unit 2080 may decode the flag indicating whether to perform inter prediction on the AC coefficient of the processing target node, and use the value of the flag. Such a flag may be decoded for each node or may be decoded for each hierarchy. Such a flag may be decoded only when it is determined that inter prediction is executable, and a determination may be made. Such a flag may be included in slice data.

In Step S28111, the RAHT unit 2080 performs inter prediction on the AC coefficient of the processing target node. This will be described in detail later.

In Step S28112, the RAHT unit 2080 performs intra prediction on the AC coefficient of the processing target node. This will be described in detail later.

In Step S28113, the processing in Step S28104 ends. Note that the conditional branch in Step S28109 may be omitted.

In the processing of inter prediction in Step S28111, processing equivalent to the intra prediction in Step S28112 may be performed together, and prediction may be performed by combining the results of the inter prediction and the intra prediction. This will be described in detail later.

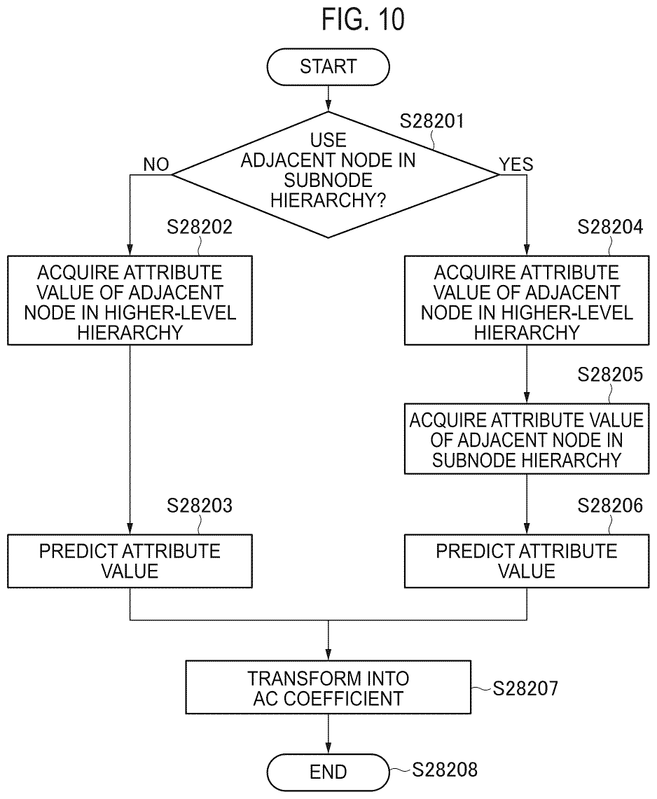

FIG. 10 is a flowchart illustrating an example of processing of intra prediction in Step S28112.

As illustrated in FIG. 10, in Step S28201, the RAHT unit 2080 determines whether to perform intra prediction using adjacent nodes in the subnode hierarchy. For the determination, the RAHT unit 2080 may refer to raht_subnode_prediction_enable_flag and use the value thereof.

When adjacent nodes in the subnode hierarchy are not used, the RAHT unit 2080 performs the intra prediction only using the adjacent nodes in the higher-level hierarchy.

Here, the adjacent nodes in the higher-level hierarchy are 7 nodes, including 3 nodes face-adjacent to the decoding target node, 3 nodes edge-adjacent to the decoding target node, and the parent node itself, among a total of 19 nodes, including 6 nodes face-adjacent to the parent node of the decoding target node, 12 nodes edge-adjacent to the parent node of the decoding target node, and the parent node itself.

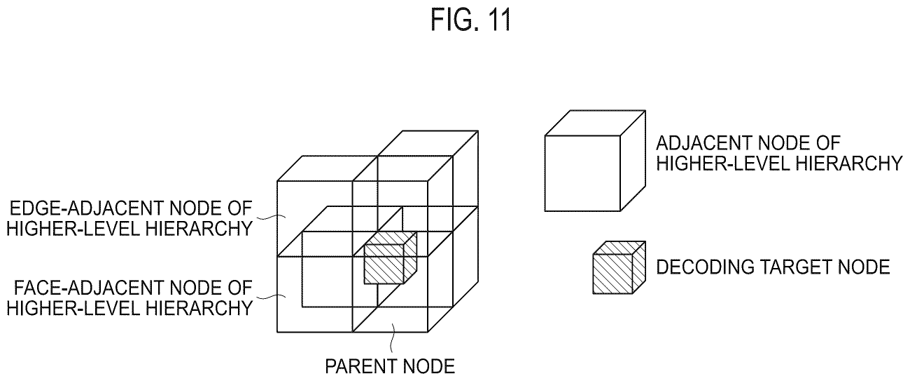

FIG. 11 is a diagram illustrating a relationship between a decoding target node and an adjacent node in a higher-level hierarchy.

When adjacent nodes in the subnode hierarchy are used, the RAHT unit 2080 performs intra prediction using adjacent nodes in the higher-level hierarchy together with the adjacent nodes in the subnode hierarchy.

Here, the adjacent nodes in the subnode hierarchy are decoded nodes face-adjacent or edge-adjacent to the decoding target node among the subnodes of the adjacent nodes in the higher-level hierarchy.

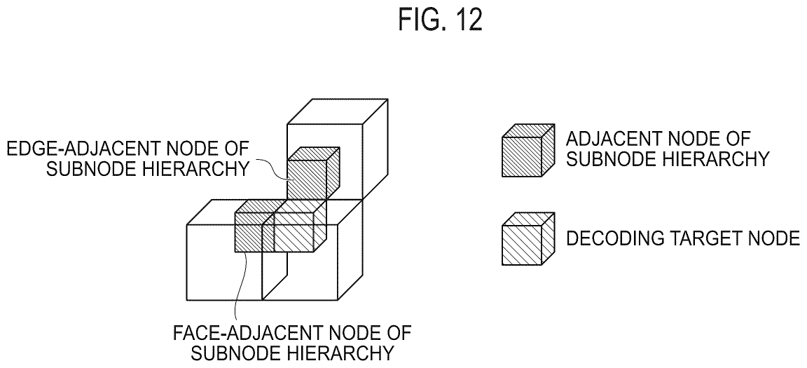

FIG. 12 is a diagram illustrating a relationship between the decoding target node and the adjacent node in the subnode hierarchy.

As a result of the determination, when intra prediction is performed without using adjacent nodes in the subnode hierarchy, the present operation proceeds to Step S28202, and when intra prediction is performed using adjacent nodes in the subnode hierarchy, the present operation proceeds to Step S28204.

In Step S28202, the RAHT unit 2080 acquires attribute values of the adjacent nodes in the higher-level hierarchy.

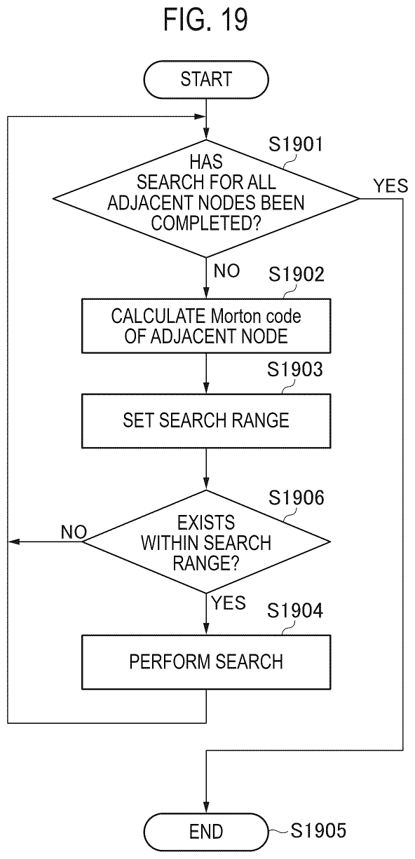

The processing of acquiring the attribute value can be realized in two stages of, for example, processing of searching for the adjacent node and processing of acquiring the attribute value from the adjacent node specified in the search processing. Hereinafter, an example of the processing of searching for the adjacent node will be described with reference to FIGS. 19 to 21.

FIG. 19 is a flowchart illustrating an example of adjacent node search processing of the higher-level hierarchy of the decoding target node.

Note that, in FIG. 19, similarly to FIG. 11, the higher-level hierarchy node of the decoding target node is specially referred to as a parent node.

In addition, hereinafter, in FIGS. 19 to 21, it is assumed that the Morton codes corresponding to the positions of the respective nodes of the higher-level hierarchy are stored in ascending order of the Morton codes on a one-dimensional array (hereinafter, referred to as a higher-level hierarchy node array).

Furthermore, it is assumed that the index (hereinafter, referred to as a parent node index) in which the Morton code of the parent node is stored on the one-dimensional array is known in advance.

As illustrated in FIG. 19, in Step S1901, the RAHT unit 2080 checks whether or not the search for all the adjacent nodes in the higher-level hierarchy has been completed.

In a case where the search for all the adjacent nodes has been completed, the present operation proceeds to Step S1905, and the processing ends. Meanwhile, when the search for all the adjacent nodes has not been completed, the present operation proceeds to Step S1902.

In Step S1902, the RAHT unit 2080 calculates the Morton code corresponding to the position of the adjacent node to be searched.

Specifically, for example, the RAHT unit 2080 may first convert the Morton code corresponding to the position of the parent node into a value of orthogonal coordinates (x, y, z), second calculate coordinates (x′, y′, z′) of the adjacent node on the orthogonal coordinate space, and third convert the orthogonal coordinates of the adjacent node again into the Morton code, thereby calculating the Morton code corresponding to the position of the adjacent node to be searched.

After the calculation of the Morton code is completed, the present operation proceeds to Step S1903.

In Step S1903, the RAHT unit 2080 sets a search range. Here, the search range is a range up to how far an index is searched with reference to the parent node index in the higher-level hierarchy node array.

When the Morton code of the adjacent node is smaller than the Morton code of the parent node, the start point and the end point of the search range can be set as follows.

Search range=min(Morton code of parent node−Morton code of adjacent node, maximum search range)

Start point of search range=max(parent node index−search range, 0)

End point of search range=parent node index−1

Here, min(a,b) is a function that returns the smaller value of two arguments a and b. In addition, max(a,b) is a function that returns the larger value of two arguments a and b. The maximum search range is the maximum value of the search range determined in advance.

The value of the maximum search range may be decoded from a header such as SPS, APS, or ASH. For example, the RAHT unit 2080 may use the value of raht_prediction_search_range as the value of the maximum search range.

Meanwhile, when the Morton code of the adjacent node is larger than the Morton code of the parent node, the start point and the end point of the search range can be set as follows.

Search range=min(Morton code of adjacent node−Morton code of parent node, maximum search range)

Start point of search range=parent node index+1

End point of search range=min(Morton code of parent node+search range, number of nodes in higher-level hierarchy−1)

As described above, after the start point and the end point of the search are determined, the present operation proceeds to Step S1906.

In Step S1906, the RAHT unit 2080 determines whether the adjacent node to be searched is not stored or is likely to be stored between the start point and the end point of the search set in Step S1903.

In a case where the RAHT unit determines that the adjacent node is not stored, the RAHT unit 2080 determines that there is no adjacent node to be searched for, proceeds to Step S1901, and searches for a next adjacent node.

Meanwhile, in a case where it is determined that there is a possibility that the adjacent node is stored, the RAHT unit 2080 proceeds to the next Step S1904 and performs the search.

Here, such determination can be executed, for example, as follows.

When the Morton code of the adjacent node is smaller than the Morton code of the parent node, the RAHT unit 2080 checks the Morton code of the node stored in the index corresponding to the start point of the search range.

When the Morton code of the node stored in the index corresponding to the start point of the search range is larger than the Morton code of the adjacent node, the RAHT unit 2080 determines that the adjacent node to be searched is not stored between the start point and the end point of the search.

Otherwise (when the Morton code of the node stored in the index corresponding to the start point of the search range is equal to or less than the Morton code of the adjacent node), the RAHT unit 2080 determines that there is a possibility that the adjacent node to be searched is stored between the start point and the end point of the search.

Here, when the index corresponding to the start point of the search range is 0, the RAHT unit 2080 may determine that there is a possibility that the adjacent node to be searched is stored between the start point and the end point of the search.

Further, when “parent node index−the index corresponding to the start point” is equal to or less than the maximum search range, the RAHT unit 2080 may determine that there is a possibility that the adjacent node to be searched is stored between the start point and the end point of the search.

Meanwhile, when the Morton code of the adjacent node is larger than the Morton code of the parent node, the RAHT unit 2080 checks the Morton code of the node stored in the index corresponding to the end point of the search range.

When the Morton code of the node stored in the index corresponding to the end point of the search range is smaller than the Morton code of the adjacent node, the RAHT unit 2080 determines that the adjacent node to be searched is not stored between the start point and the end point of the search.

Otherwise (when the Morton code of the node stored in the index corresponding to the end point of the search range is equal to or more than the Morton code of the adjacent node), the RAHT unit 2080 determines that there is a possibility that the adjacent node to be searched is stored between the start point and the end point of the search.

Here, when the index corresponding to the end point of the search range is “the number of nodes in the higher-level hierarchy−1”, the RAHT unit 2080 may determine that there is a possibility that the adjacent node to be searched is stored between the start point and the end point of the search.

Further, when the “index corresponding to the end point−parent node index” is equal to or less than the maximum search range, the RAHT unit 2080 may determine that there is a possibility that the adjacent node to be searched is stored between the start point and the end point of the search.

In other words, the above processing can be said to be processing of determining whether the adjacent node to be searched for is not present or is likely to be present within the search range on the basis of the Morton code of the node stored at the start point or the end point of the search range.

In this manner, it is determined whether there is a possibility that the node to be searched is present or not present in the search range prior to the search processing, and when there is no node to be searched, unnecessary processing can be reduced by omitting the search processing. The execution time can be reduced in the case of software implementation, and the power consumption can be reduced in the case of hardware implementation.

In Step S1904, the RAHT unit 2080 searches for an element in which the same Morton code as that of the adjacent node is stored from the range of the higher-level hierarchy node array designated by the start point and the end point of the search described above.

Here, in a case where an element in which the same Morton code as that of the adjacent node is stored is found, the RAHT unit 2080 returns an index of the element.

Meanwhile, when an element storing the same Morton code as that of the adjacent node is not found, the RAHT unit 2080 returns a value (for example, −1) indicating that the adjacent node cannot be found. At this time, since the Morton codes are stored in ascending order in the higher-level hierarchy node array, the RAHT unit 2080 can perform the search with a smaller number of searches than the entire search by using binary search or the like.

After the above-described processing is completed, the present operation proceeds to Step S1901 to search for the next adjacent node.

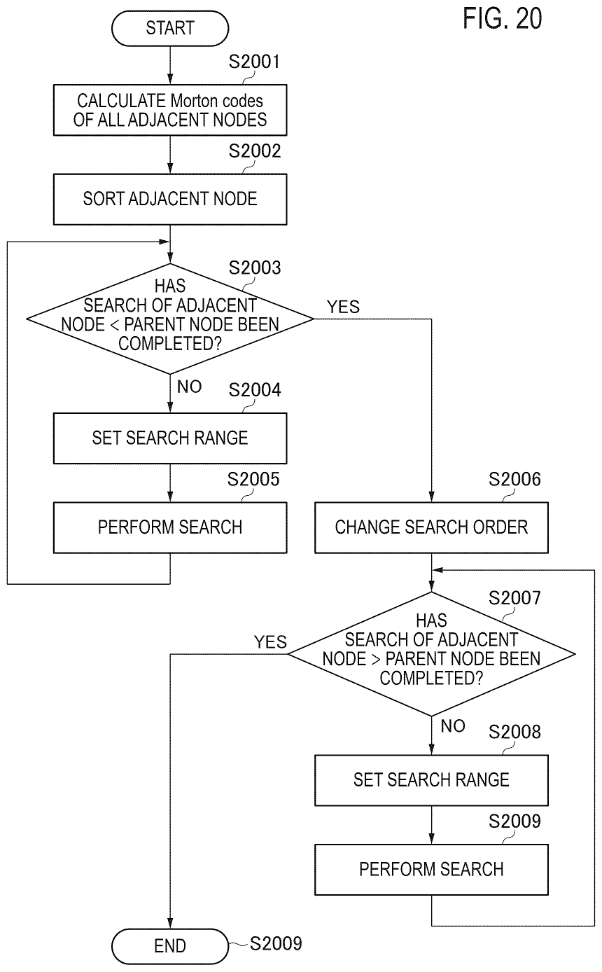

FIG. 20 is a flowchart illustrating an example of the adjacent node search processing of the higher-level hierarchy of the decoding target node. Hereinafter, an example of the adjacent node search processing of the higher-level hierarchy will be described with reference to FIG. 20.

As illustrated in FIG. 20, in Step S2001, the RAHT unit 2080 calculates Morton codes of all the adjacent nodes.

Here, the method of calculating the Morton code is similar to the method described in Step S1902. The difference from Step S1902 is that the Morton codes of all the adjacent nodes (for example, 19 nodes) are calculated. After the calculation processing is completed, the present operation proceeds to Step S2002.

In Step S2002, the RAHT unit 2080 sorts the adjacent nodes in ascending order, for example, on the basis of the Morton code calculated in Step S2001. Hereinafter, the adjacent node search processing is performed in ascending order of the value of the Morton code.

In Step S2003, the RAHT unit 2080 determines whether or not the search for the adjacent node having a smaller Morton code than the parent node among the adjacent nodes has been completed.

When the search is completed, the present operation proceeds to Step S2006. Meanwhile, when the search is not finished, the present operation proceeds to Step S2004.

In Step S2004, the RAHT unit 2080 sets the search range. For example, the RAHT unit 2080 sets such a search range by the following method.

Search range=min(min(parent node index−index of latest discovered another adjacent node, Morton code of parent node−Morton code of adjacent node), maximum search range)

Start point of search range=max(parent node index−search range, 0)

End point of search range=parent node index−1

Here, the difference from Step S1903 is that the search range is set using the index of another adjacent node found immediately before. Since the adjacent nodes are searched for in ascending order of the Morton code, it is ensured that the Morton code of the currently searched adjacent node is a value larger than that of the Morton code of another adjacent node found immediately before. Similarly, it is ensured that the index of the element storing the Morton code of the currently searched adjacent node in the hierarchy node array is larger than the index of the element storing the Morton code of another discovered adjacent node. Therefore, by using the index of another adjacent node found immediately before, the search range can be reduced, and the number of search processing times and the time related to the search can be reduced.

Note that the RAHT unit 2080 may initialize the value of the index of another adjacent node discovered immediately before to 0, and thereafter, may update the value every time the adjacent node is discovered. After the above-described process ends, the present operation proceeds to Step S2005.

In Step S2005, the RAHT unit 2080 performs search processing similar to that in Step S1904.

In Step S2006, the RAHT unit 2080 changes the search order. Specifically, in the processing so far, the RAHT unit 2080 performs the search in ascending order of the Morton codes of the adjacent nodes, but changes the search in descending order of the Morton codes. After changing the search order, the present operation proceeds to Step S2007.

In Step S2007, the RAHT unit 2080 determines whether or not the search for a node having a larger Morton code than the parent node among the adjacent nodes has been completed.

In a case where all such searches have been completed, the present operation proceeds to Step S2009 and terminates the processing. In a case where all such searches have not been completed, the present operation proceeds to Step S2008.

In Step S2008, the RAHT unit 2080 sets the search range as follows. Here, similarly to Step S2004, the RAHT unit 2080 uses the index of another adjacent node found immediately before.

Search range=min(min(index of another adjacent node found immediately before−parent node index, Morton code of adjacent node−Morton code of parent node), maximum search range)

Start point of search range=parent node index+1

End point of search range=min(Morton code of parent node+search range, number of nodes in higher−level hierarchy)

Here, since searching is performed in descending order of the Morton codes of the adjacent nodes, it is guaranteed that the Morton code currently being searched is smaller than the Morton codes of the other adjacent nodes discovered immediately before.

Note that the index of another adjacent node found immediately before may be initialized with the number of nodes in the higher-level hierarchy (=the number of elements of the higher-level hierarchy node array) at the timing of Step S2006, and thereafter, may be updated with such an index value every time an adjacent node is found.

After the search range is set as described above, the present operation proceeds to Step S2009.

In Step S2009, the RAHT unit 2080 performs search processing similar to that in Step S2005.

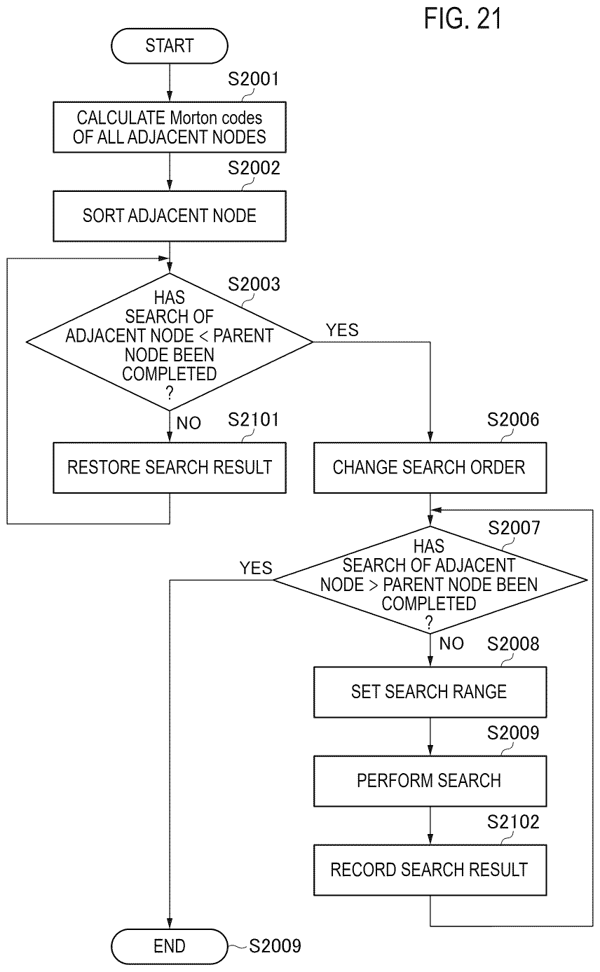

FIG. 21 is a flowchart illustrating an example of the adjacent node search processing of the higher-level hierarchy of the decoding target node. Hereinafter, an example of the adjacent node search processing of the higher-level hierarchy will be described with reference to FIG. 21. Note that the same processes as those in FIG. 20 are denoted by the same reference numerals as those in FIG. 20, and description thereof is omitted.

As illustrated in FIG. 21, in Step S2101, the RAHT unit 2080 restores the search result recorded in Step S2102 described later.

Specifically, the RAHT unit 2080 refers to information stored in the array or the like to specify the index value of the adjacent node.

In Step S2102, when the adjacent node having the Morton code larger than that of the parent node is found, the RAHT unit 2080 records the index of the parent node as the adjacent node when the adjacent node becomes the parent node.

As for the adjacent node to the parent node, when viewed from the adjacent node (even when the adjacent node becomes the parent node), the parent node becomes the adjacent node. That is, there is a symmetrical relationship.

In the present embodiment, the RAHT unit 2080 processes the parent node in the ascending order of the Morton codes.

Therefore, the RAHT unit 2080 can reduce the search processing by storing the index of the parent node as the adjacent node for the adjacent node having a larger Morton code than the parent node among the adjacent nodes of the parent node (in preparation for when the adjacent node becomes the parent node).

That is, as described in Step S2101, the adjacent node having a smaller Morton code than the parent node has already been searched when the adjacent node is the parent node. Therefore, the RAHT unit 2080 stores a result of the search and does not need to execute the search processing again.

As a result, the search processing can be reduced to about half as compared with a case where such storage is not performed.

As described above, after the attribute value of the adjacent node of the higher-level hierarchy is acquired, the present operation proceeds to Step S28203.

In Step S28203, the RAHT unit 2080 predicts the attribute value of the decoding target node.

The RAHT unit 2080 may predict the attribute value attr according to the following formula, using the acquired attribute values attrᵢ of the k adjacent nodes in the higher-level hierarchy and the weights wᵢ according to the types of the adjacent nodes i.

$$attr = \frac{{\sum }_{i} {w}_{i} {attr}_{i}}{{\sum }_{i} {w}_{i}} \qquad [ Math . 4 ]$$

Here, the RAHT unit 2080 may use a hard-coded value as the weight wᵢ depending on what type the adjacent nodes i are of among face-adjacent nodes in the higher-level hierarchy, edge-adjacent nodes in the higher-level hierarchy, and the parent node, or may refer to raht_prediction_weights and calculate the weight wᵢ from the value thereof.

After the prediction of the attribute value is completed, the present operation proceeds to Step S28207.

In Step S28204, the RAHT unit 2080 acquires the attribute values of the adjacent nodes in the higher-level hierarchy.

Here, a target for obtaining the attribute value is a node in which a sub-node of each adjacent node has not been decoded among the adjacent nodes of the higher-level hierarchy, or a node in which a subnode face-adjacent to or edge-adjacent to the decoding target node does not exist even when the sub-node has been decoded among the adjacent nodes of the higher-level hierarchy.

After the acquisition of the attribute values is completed, the present operation proceeds to Step S28205.

In Step S28205, the RAHT unit 2080 acquires the attribute values of adjacent nodes in the subnode hierarchy. After the attribute values of the adjacent nodes in the subnode hierarchy are acquired, the present operation proceeds to Step S28206.

In Step S28206, the RAHT unit 2080 predicts the attribute value of the decoding target node.

The RAHT unit 2080 may predict the attribute value attr according to the following formula, using the acquired attribute values attrᵢ of the k adjacent nodes in the higher-level hierarchy and the adjacent nodes in the subnode hierarchy and the weights wᵢ according to the adjacent node type i.

$$attr = \frac{{\sum }_{i} {w}_{i} {attr}_{i}}{{\sum }_{i} {w}_{i}} \qquad [ Math . 5 ]$$

Here, the RAHT unit 2080 may use a hard-coded value as the weight wᵢ depending on what type the adjacent nodes i are of among face-adjacent nodes in the higher-level hierarchy, edge-adjacent nodes in the higher-level hierarchy, the parent node, face-adjacent nodes in the subnode hierarchy, and edge-adjacent nodes in subnode hierarchy, or may refer to raht_prediction_weights and calculate the weight wᵢ from the value thereof.

After the prediction of the attribute value is completed, the present operation proceeds to Step S28207.

In Step S28207, the RAHT unit 2080 transforms the predicted attribute value into an AC coefficient. The AC coefficient is generated by performing RAHT on the predicted attribute value. For example, the RAHT unit 2080 may use the method described in Non Patent Literature 1 as the transform method.

In Step S28207, instead of converting the predicted attribute value into the AC coefficient, the RAHT unit 2080 may convert the residual of the decoded AC coefficient into the residual of the attribute value, and add the predicted value and the residual in the attribute value domain.

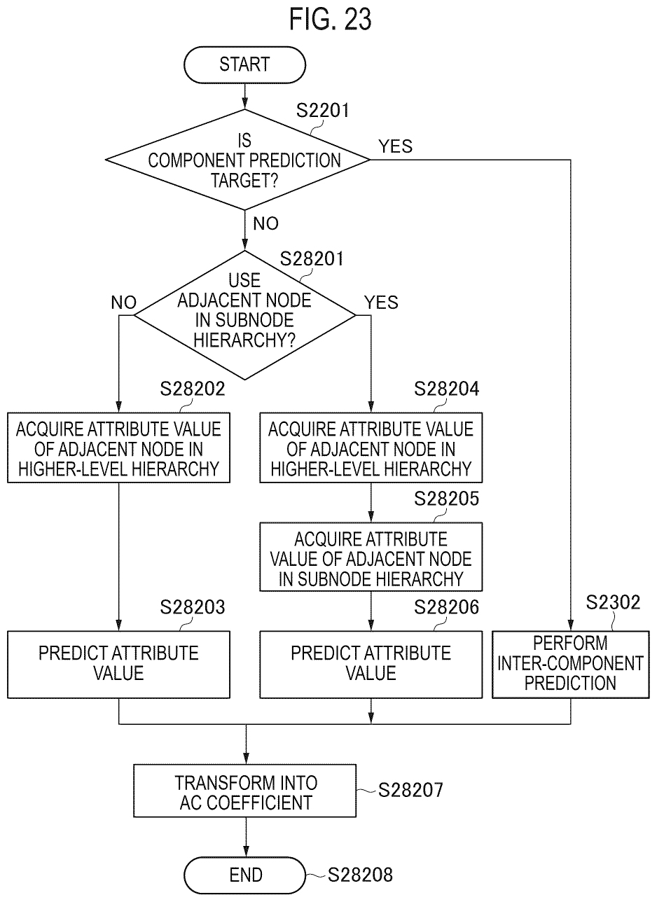

FIG. 23 is a flowchart illustrating an example of processing of the intra prediction in Step S28112. An example of the intra prediction processing will be described below with reference to FIG. 23. Note that the same processes as those in FIG. 10 are denoted by the same reference numerals as those in FIG. 10, and description thereof is omitted.

Further, in FIG. 23, the attribute information of the decoded point cloud data includes a plurality of components, and the processing of FIG. 23 will be described as processing for one of the components.

By applying the processing of FIG. 23 to each component for each decoding target node, signals of all components included in the decoding target node can be decoded.

In Step S2201, the RAHT unit 2080 determines whether or not the component is the target of the inter-component prediction.

Here, the RAHT unit 2080 may determine whether or not the component is the target of the inter-component prediction on the basis of the value of the syntax element included in the header such as SPS, APS, or ASH.

For example, when the value of raht_inter_comp_pred_enabled is “1”, the RAHT unit 2080 may predict the chroma signal from the luminance signal. In such a case, the target of the inter-component prediction is the chroma signal (Cb signal and Cr signal).

In addition, the RAHT unit 2080 may perform the inter-component prediction between the chroma signals. For example, when the value of raht_last_comp_pred_enabled is “1”, the RAHT unit 2080 may predict the Cr signal from the Cb signal. In such a case, the target of the inter-component prediction is the Cr signal.

Here, it is assumed that the Y signal, the Cb signal, and the Cr signal are decoded in this order. When the inter-component prediction is performed, only a signal whose decoding is completed before the signal to be predicted can be used.

In a case where the component is the target of the inter-component prediction, the present operation proceeds to Step S2302, and otherwise, the present operation proceeds to Step S28201.

In Step S2302, the RAHT unit 2080 performs the inter-component prediction.

Hereinafter, a case where the Cb signal is predicted from the luminance signal will be described as an example. However, the Cr signal can be predicted from the luminance signal, and the Cr signal can be predicted from the Cb signal. Here, the AC coefficient of the luminance signal calculated in Step S28207 is Y.

The predicted value Crp of the AC coefficient of the Cb signal can be calculated, for example, as in the following formula.

$$Crp = a \times Y + b$$

Here, a and b are prediction coefficients. The RAHT unit 2080 may decode the prediction coefficient from the header such as SPS, APS, or ASH.

For example, the RAHT unit 2080 may decode such AC coefficients from the values of raht_last_comp_pred_coeff_diff [dpth] and raht_inter_comp_pred_coeff_diff [dpth].

Alternatively, the RAHT unit 2080 may calculate the prediction coefficient from another already decoded AC coefficient value.

Specifically, for example, the RAHT unit 2080 may calculate and use an AC coefficient that minimizes the sum of square errors in a case where the AC coefficient of the Cb signal is predicted from the AC coefficient value of the luminance signal of another already decoded AC coefficient by the above formula.

The above-described processing can be analytically calculated by using the least squares method. At this time, the RAHT unit 2080 may use all the decoded AC coefficients for calculation of the AC coefficients.

Furthermore, the RAHT unit 2080 may use only the most recently decoded N AC coefficients based on the AC coefficient for calculation of the AC coefficient. The RAHT unit 2080 may determine the number of N before decoding, or may decode the value of N from the header such as SPS, APS, or ASH.

For example, the RAHT unit 2080 may use the value of raht_coeff_calc_range as N.

Further, the RAHT unit 2080 may calculate the AC coefficient by using the weighted least squares method instead of the simple least squares method.

Specifically, the RAHT unit 2080 may perform weighting based on an absolute value of a difference between the value Y of the Y signal of the AC coefficient and the Y signal of the already decoded AC coefficient or a square value of the difference. At this time, the weight may be defined so as to become heavier as the difference becomes smaller.

Although the case where the RAHT unit 2080 performs the above prediction in the AC coefficient domain has been described as an example, the RAHT unit 2080 may perform the above prediction in the attribute signal domain.

That is, the RAHT unit 2080 may predict the attribute signal value of the Cb signal from the attribute signal value of the Y signal.

Although the example in which the RAHT unit 2080 uses the attribute value predicted in Step S28206 directly for transformation into the AC coefficient in Step S28207 has been described above, the RAHT unit 2080 may transform the predicted attribute value into the AC coefficient after smoothing the predicted attribute value.

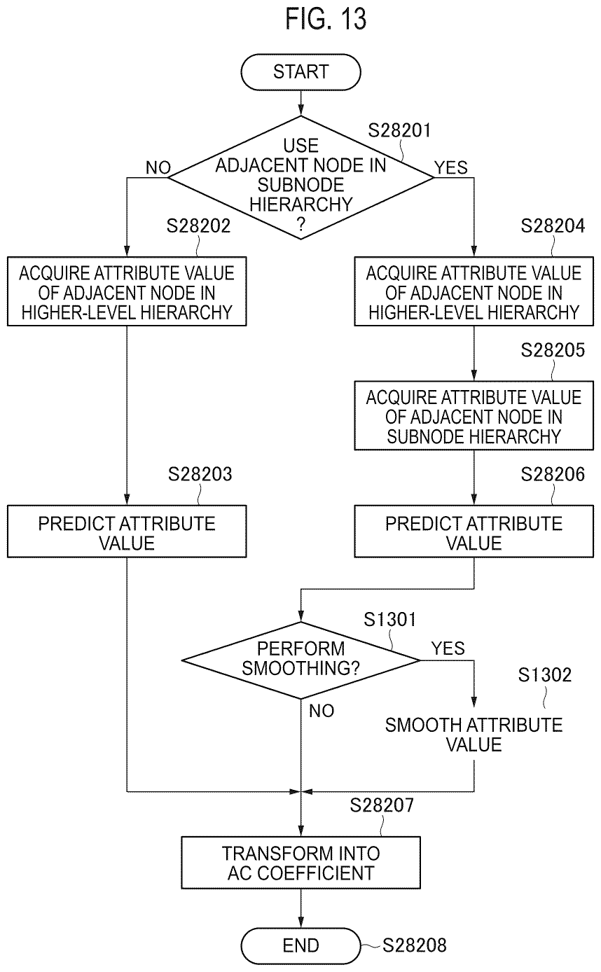

For example, as illustrated in FIG. 13, after predicting the attribute value, the RAHT unit 2080 may determine whether to perform smoothing in Step S1301.

In such determination, the RAHT unit 2080 may refer to raht_smoothing_enable_flag and use the value thereof.

When smoothing is performed, the present operation proceeds to Step S1302. When smoothing is not performed, the present operation proceeds to Step S28207.

In Step S1302, the RAHT unit 2080 may smooth the attribute value.

For example, the RAHT unit 2080 may obtain a smoothed attribute value Attr_{smoothing} of the decoding target node by calculating a weighted average using the attribute values Attrᵢ and the weights ai predicted in the subnodes i in the same parent node as the decoding target node as follows.

$$A t t {r}_{s m o o t h i n g} = \frac{{\sum }_{i} {a}_{i} {Attr}_{i}}{{\sum }_{i} {a}_{j}} \qquad [ Math . 6 ]$$

Here, the subnodes i that are targets of the RAHT unit 2080 may be nodes that are face-adjacent to the decoding target node, or may be all subnodes in the same parent node.

Further, the RAHT unit 2080 may use a hard-coded value as the weight αᵢ, or may refer to raht_smoothing_weighted_average_weights and use the value thereof.

Furthermore, the RAHT unit 2080 may obtain a smoothed attribute value Attr_{smoothing} of the decoding target node by performing clipping using the predicted value Attr₀ of the decoding target node itself, the attribute values Attrᵢ and the weights Si predicted in the subnodes i other than the decoding target node among the subnodes in the same parent node as the decoding target node, and the thresholds Thᵣ as follows.

$$Att {r}_{smoothing} + {Attr}_{o} + \frac{{\sum }_{i} {β}_{i} Clip 3 ( {Attr}_{i} - {Attr}_{o} , - Thr , + Thr )}{{\sum }_{i} {β}_{i}} \qquad [ Math . 7 ]$$

Here, the clipping is processing in which a maximum value is output when an input value is larger than a predetermined maximum value, a minimum value is output when the input value is smaller than a predetermined minimum value, and the input value is used as it is as an output value otherwise.

The clipping function Clip3 is defined by the following mathematical formula.

$$Clip 3 ( val , min , max ) = \{ \begin{matrix}min & if ( val < min ) \\ max & if ( val > max ) \\ val & Otherwise\end{matrix} \qquad [ Math 8 ]$$

Here, the target subnodes i that are targets of the RAHT unit 2080 may be nodes that are face-adjacent to the decoding target node, may be nodes that are face-adjacent and edge-adjacent to the decoding target node, or may be all subnodes in the same parent node.

In addition, the RAHT unit 2080 may use a hard-coded value as the weight βᵢ, or may refer to raht_smoothing_clipping_weights and use the value thereof.

In addition, the RAHT unit 2080 may use a hard-coded value as the threshold Thᵣ, or may refer to raht_smoothing_clipping_threshold and use the value thereof.

Although the example in which the RAHT unit 2080 decodes the AC coefficients of both chroma signals and luminance signals has been described above, the RAHT unit 2080 may skip decoding the AC coefficients of the chroma signals only for the lowest-level hierarchy of the octree.

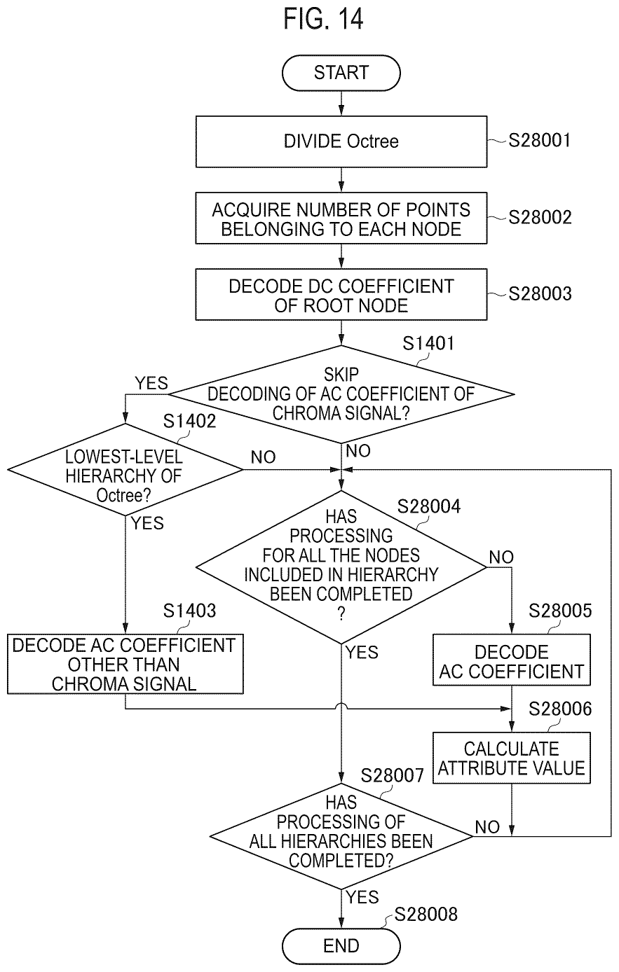

For example, as illustrated in FIG. 14, in Step S1401, the RAHT unit 2080 may determine whether to skip decoding the AC coefficients of the chroma signals only for the lowest-level hierarchy of the octree.

When it is skipped, the present operation proceeds to Step S1402. When it is not skipped, the present operation proceeds to Step S28004.

In Step S1402, the RAHT unit 2080 determines whether the decoding target node is in the lowest-level hierarchy of the octree.

When the decoding target node is in the lowest-level hierarchy, the present operation proceeds to Step S1403. When the decoding target node is not in the lowest-level hierarchy, the present operation proceeds to Step S28004.

In Step S1403, the RAHT unit 2080 decodes AC coefficients other than those of the chroma signals.

The RAHT unit 2080 performs processing similar to that in Step S28004 for decoding AC coefficients other than those of the chroma signals, and calculates attribute values in subsequent Step S28005 with the AC coefficients of the chroma signals set to 0.

After the decoding of the AC coefficients other than those of the chroma signals is completed, the present operation proceeds to Step S28006.

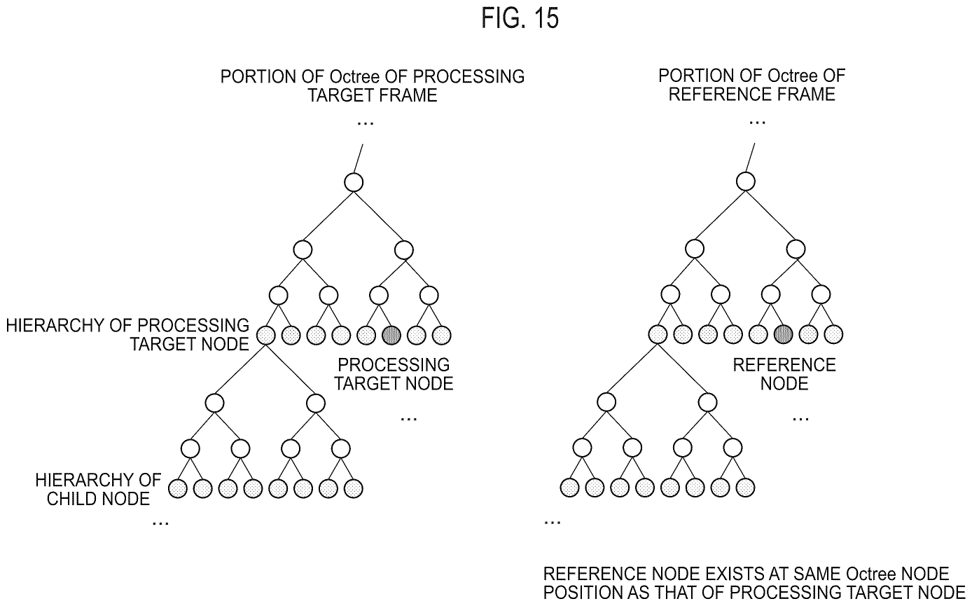

FIG. 15 is a diagram illustrating an example of inter prediction processing in Step S28111.

The RAHT unit 2080 predicts AC coefficients of processing target nodes by using information on reference nodes, which are corresponding nodes in the reference frame. Here, the information on reference nodes may be attribute values or AC coefficients thereof. Furthermore, the reference frame refers to another decoded frame, and the information thereof may be included in a pre-frame buffer 2120.

The RAHT unit 2080 may apply the same octree structure to the reference frame as the processing target frame. In such a case, a node may be set at a position where there is no point. Such a node is referred to as an empty node. When the reference node is an empty node, the RAHT unit 2080 may disable the inter prediction in Step S28110.

The RAHT unit 2080 may apply an octree to the reference frame independently of the processing target frame, and set a different octree structure to the reference frame from the processing target frame. In such a case, there is a possibility that nodes do not necessarily exist at the same positions as those in the processing target frame. When no reference node is found at the position corresponding to the processing target node, the RAHT unit 2080 may disable the inter prediction in Step S28143.

When the reference node is an empty node or when no reference node is found, the RAHT unit 2080 may estimate and interpolate information on the reference node by using information on nodes at nearby positions in the reference frame.

For example, the RAHT unit 2080 may estimate and interpolate an average value of attribute values or AC coefficients of the adjacent nodes, the nearest nodes, or the k nearest nodes with respect to the reference node position as the attribute value or the AC coefficient of the reference node.

The RAHT unit 2080 may predict the AC coefficient of the processing target node, for example, from the attribute value of the reference node.

Specifically, the RAHT unit 2080 may obtain a predicted value Attr_{pred} of the attribute value of the processing target node by using a value Attrᵢₙₜₑᵣ of the decoded attribute value of the reference node, and obtain a predicted value AC_{pred} of the AC coefficient of the processing target node by applying RAHT to the predicted value Attr_{pred} of the attribute value of the processing target node.

$${Attr}_{p r e d} = {Attr}_{i n t e r}$$

$${A C}_{p r e d} = RAHT ( {Attr}_{p r e d} )$$

The RAHT unit 2080 may directly predict the AC coefficient of the processing target node, for example, from the AC coefficient of the reference node.

Specifically, the RAHT unit 2080 may calculate the value ACᵢₙₜₑᵣ of the AC coefficient of the reference node by using RAHT in the reference frame, and use the value as the predicted value AC_{pred} of the AC coefficient of the processing target node.

$$A {C}_{p r e d} = {AC}_{inter}$$

The RAHT unit 2080 may obtain the AC coefficient of the reference node by recording the AC coefficient of each node of the reference frame in the frame buffer 2120 and referring to the value in the frame buffer 2120. In such a case, in a case where the AC coefficient of the reference node does not exist in the frame buffer 2120, the RAHT unit 2080 may disable the inter prediction in Step S28110.

Note that the RAHT unit 2080 may multiply each of Attrᵢₙₜₑᵣ and the ACᵢₙₜₑᵣ by a with a scaling factor α.

$${Attr}_{p r e d} = α {Attr}_{i n t e r}$$

$$or$$

$${AC}_{pred} = α {AC}_{inter}$$

The coefficient α may take any real number. The coefficient α may be decoded for each node or may be decoded for each hierarchy. The coefficient α may be included in the slice data.

For example, the coefficient α may be defined using the depth of the hierarchy as follows, and α′ may be decoded instead of the coefficient α.

$$α = 1 + {α}^{′} \cdot 2 - depth$$

For example, an integer β may be defined to be an integer ranging from integer a to integer b, and β may be decoded. The coefficient α may be calculated as a value obtained by adding an integer c to the decoded β and then dividing the result by the integer c as follows.

$$α = ( β + c ) / c$$

The integer β may be decoded using an exponential-Golomb code.

Alternatively, the coefficient α may be derived in a decoder.

For example, the coefficient α may be calculated using an AC coefficient ACₚₐᵣₑₙₜ of the parent node of the decoding target node and an inter-predicted value ACₚₐᵣₑₙₜ inter obtained when the parent node is decoded as follows.

$$α = {AC}_{p a r e n t} / {AC}_{parent \_ inter}$$

For example, the RAHT unit 2080 may calculate a so as to minimize the cost using AC coefficients AC_{neighbor1}, AC_{neighbor2}, . . . , and AC_{neighborN} of N adjacent nodes of the decoding target node and inter-predicted values AC_{neighbor_inter1}, AC_{neighbor_inter2}, . . . , and AC_{neighbor_interN} Obtained when the respective adjacent nodes are decoded.

The cost may be, for example, the sum of squared errors between the AC coefficients of the respective adjacent nodes and the predictors of the AC coefficients. For example, the adjacent nodes may be only face-adjacent nodes, or may be face-adjacent nodes and edge-adjacent nodes.

The RAHT unit 2080 may perform a similar operation by inter prediction of DC coefficients in Step S28003.

$$D {C}_{p r e d} = α {DC}_{i n t e r}$$

Here, the DC coefficient of the reference node is defined as DCᵢₙₜₑᵣ, and the predicted value of the DC coefficient of the root node is DC_{pred}.

In addition, the RAHT unit 2080 may calculate the predicted value of the attribute value or the AC coefficient by combining the inter prediction and the intra prediction.

For example, an example in which the RAHT unit 2080 obtains the prediction of the attribute value will be described below.

$$A t t {r}_{p r e d} = {W}_{i n t e r} \cdot {Attr}_{i n t e r} + {W}_{i n t r a} \cdot {Attr}_{i n t r a}$$

Here, Attrᵢₙₜₑᵣ and Attrᵢₙₜᵣₐ are the inter prediction and intra prediction of the attribute value, respectively. In addition, Wᵢₙₜₑᵣ and Wᵢₙₜᵣₐ are weights of the inter prediction and intra prediction, respectively. Wᵢₙₜₑᵣ and Wᵢₙₜᵣₐ may be determined depending on the depth of the processing target hierarchy such that the deeper the hierarchy, the more importance is placed on intra prediction. For example,

$${W}_{i n t e r} = 1 - depth / N$$

$${W}_{i n t r} a = depth / N$$

N is the maximum value of the depth of the hierarchy in which the inter prediction is enabled. The combination of inter prediction and intra prediction may be enabled only in a specific hierarchy. For example, the combination of inter prediction and intra prediction may be enabled only when M<depth<N. M may be any real number less than N, and may be decoded as header information such as APS.

### (Point Cloud Encoding Device 100)

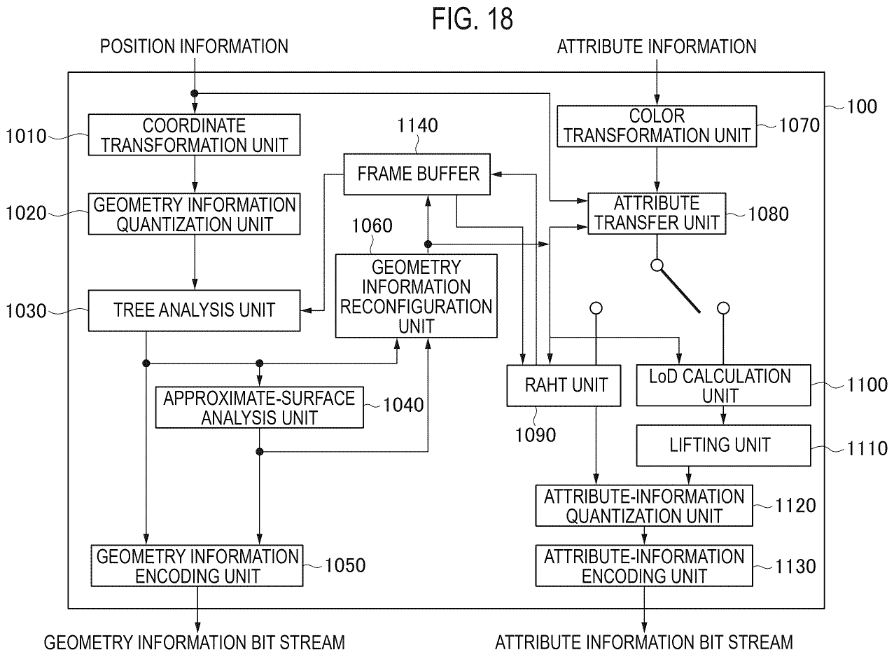

Hereinafter, the point cloud encoding device 100 according to the present embodiment will be described with reference to FIG. 18. FIG. 18 is a diagram illustrating an example of functional blocks of the point cloud encoding device 100 according to the present embodiment.

As illustrated in FIG. 18, the point cloud encoding device 100 includes a coordinate transformation unit 1010, a geometry information quantization unit 1020, a tree analysis unit 1030, an approximate-surface analysis unit 1040, a geometry information encoding unit 1050, a geometry information reconfiguration unit 1060, a color transformation unit 1070, an attribute transfer unit 1080, an RAHT unit 1090, an LoD calculation unit 1100, a lifting unit 1110, an attribute-information quantization unit 1120, an attribute-information encoding unit 1130, and a frame buffer 1140.

The coordinate transformation unit 1010 is configured to perform transformation processing from a three-dimensional coordinate system of an input point cloud to an arbitrary different coordinate system. In the coordinate transformation, for example, x, y, and z coordinates of the input point cloud may be transformed into arbitrary s, t, and u coordinates by rotating the input point cloud. Furthermore, as one of variations of the transformation, the coordinate system of the input point cloud may be used as it is.

The geometry information quantization unit 1020 is configured to perform quantization of position information of the input point cloud after the coordinate transformation and removal of points having overlapping coordinates. Note that, in a case where a quantization step size is 1, the position information of the input point cloud matches position information after quantization. That is, a case where the quantization step size is 1 is equivalent to a case where quantization is not performed.

The tree analysis unit 1030 is configured to generate an occupancy code indicating which node in an encoding target space a point is present, based on a tree structure to be described later, by using the position information of the point cloud after quantization as an input.

In the present processing, the tree analysis unit 1030 is configured to recursively partition the encoding target space into cuboids to generate the tree structure.

Here, in a case where a point is present in a certain cuboid, the tree structure can be generated by recursively performing processing of dividing the cuboid into a plurality of cuboids until the cuboid has a predetermined size. Each of such cuboids is referred to as a node. In addition, each cuboid generated by dividing the node is referred to as a child node, and the occupancy code is a code expressed by 0 or 1 as to whether or not a point is included in the child node.

As described above, the tree analysis unit 1030 is configured to generate the occupancy code while recursively dividing the node to a predetermined size.

In the present embodiment, it is possible to use a method called “octree” in which octree division is recursively carried out with the above-described cuboids always as cubes, and a method called “QtBt” in which quadtree division and binary tree division are carried out in addition to octree division.

Here, whether or not to use “QtBt” is transmitted to the point cloud decoding device 200 as control data.

Alternatively, it may be specified that Predictive coding using any tree configuration is to be used. In such a case, the tree analysis unit 1030 determines the tree structure, and the determined tree structure is transmitted to the point cloud decoding device 200 as control data.

For example, the control data of the tree structure may be configured to be decoded by the procedure described in FIGS. 5 to 14.

The approximate-surface analysis unit 1040 is configured to generate approximate-surface information by using the tree information generated by the tree analysis unit 1030.

For example, in a case where a point cloud is densely distributed on the surface of an object when decoding three-dimensional point cloud data of the object or the like, the approximate-surface information approximates and expresses a region in which the point cloud is present by a small plane instead of decoding each point cloud.

Specifically, the approximate-surface analysis unit 1040 may be configured to generate the approximate-surface information by, for example, a method called “Trisoup”. In addition, when decoding a sparse point cloud acquired by Lidar or the like, the present processing can be omitted.

The geometry information encoding unit 1050 is configured to encode syntax such as the occupancy code generated by the tree analysis unit 1030 and the approximate-surface information generated by the approximate-surface analysis unit 1040 to generate a bit stream (geometry information bit stream). Here, the bit stream may include, for example, the syntax described in FIG. 4.

The encoding processing is, for example, context-adaptive binary arithmetic encoding processing. Here, for example, the syntax includes control data (flags and parameters) for controlling the decoding processing of the position information.

The geometry information reconfiguration unit 1060 is configured to reconfigure geometry information (a coordinate system assumed by the encoding processing, that is, the position information after the coordinate transformation in the coordinate transformation unit 1010) of each point of the point cloud data to be encoded based on the tree information generated by the tree analysis unit 1030 and the approximate-surface information generated by the approximate-surface analysis unit 1040.

The frame buffer 1140 is configured to use, as input, the geometry information reconfigured by the geometry information reconfiguration unit 1060 and store the geometry information as a reference frame.

The stored reference frame is read from the frame buffer 1140 and used as a reference frame in a case where the tree analysis unit 1030 performs inter prediction of temporally different frames.

Here, which time reference frame is used for each frame may be determined based on, for example, a value of a cost function representing encoding efficiency, and information of the reference frame to be used may be transmitted to the point cloud decoding device 200 as the control data.

The color transformation unit 1070 is configured to perform color transformation when attribute information of the input is color information. The color transformation is not necessarily performed, and whether or not to perform the color transformation processing is encoded as a part of the control data and transmitted to the point cloud decoding device 200.

The attribute transfer unit 1080 is configured to correct an attribute value so as to minimize distortion of the attribute information based on the position information of the input point cloud, the position information of the point cloud after the reconfiguration in the geometry information reconfiguration unit 1060, and the attribute information after the color change in the color transformation unit 1070. As a specific correction method, for example, the method described in Non Patent Literature 1 can be applied.

The RAHT unit 1090 is configured to use, as input, the attribute information after the transfer by the attribute transfer unit 1080 and the geometry information generated by the geometry information reconfiguration unit 1060, and to generate residual information of each point by using a type of Haar transform called region adaptive hierarchical transform (RAHT). As specific processing of the RAHT, for example, the method described in Literature 2 described above can be used.

The information to be decoded includes DC components (DC coefficients) and AC components (AC coefficients) of the attribute information generated by using RAHT in encoding processing, and is transformed into the attribute information by using inverse transform of RAHT in decoding processing.

As specific RAHT processing, for example, the method described in Non Patent Literature 1 described above can be used.

The LoD calculation unit 1100 is configured to generate a level of detail (LoD) using the geometry information generated by the geometry information reconfiguration unit 1060 as an input.

The LoD is information for defining a reference relationship (a point that refers to and a point to be referred to) for implementing predictive coding such as encoding or decoding of a prediction residual by predicting attribute information of a certain point from attribute information of another certain point.

In other words, the LoD is information defining a hierarchical structure in which each point included in the geometry information is classified into a plurality of levels, and for a point belonging to a lower level, an attribute is encoded or decoded using attribute information of a point belonging to an upper level.

As a specific LoD determination method, for example, the method described in Literature 2 described above may be used.

The lifting unit 1110 is configured to generate the residual information by lifting processing using the LoD generated by the LoD calculation unit 1100 and the attribute information after the attribute transfer in the attribute transfer unit 1080.

As specific processing of the lifting, for example, the method described in Non Patent Literature 1 described above may be used.

The attribute-information quantization unit 1120 is configured to quantize the residual information output from the RAHT unit 1090 or the lifting unit 1110. Here, a case where the quantization step size is 1 is equivalent to a case where quantization is not performed.

The attribute-information encoding unit 1130 is configured to perform encoding processing using the quantized residual information or the like output from the attribute-information quantization unit 1120 as syntax to generate a bit stream (attribute information bit stream) regarding the attribute information.

The encoding processing is, for example, context-adaptive binary arithmetic encoding processing. Here, for example, the syntax includes control data (flags and parameters) for controlling the decoding processing of the attribute information.

The point cloud encoding device 100 is configured to perform the encoding processing using the position information and the attribute information of each point in a point cloud as inputs and output the geometry information bit stream and the attribute information bit stream by the above processing.

The point cloud encoding device 100 and the point cloud decoding device 200 described above may be implemented as programs that cause a computer to execute each function (each step).

In the above embodiments, the present invention has been described using the application to the point cloud encoding device 100 and the point cloud decoding device 200 as an example. However, the present invention is not limited to such examples and can similarly be applied to a point cloud encoding/decoding system that incorporates the respective functions of the point cloud encoding device 100 and the point cloud decoding device 200.

According to the present embodiment, for example, comprehensive improvement in service quality can be realized in moving image communication, and thus, it is possible to contribute to the goal 9 “Build resilient infrastructure, promote inclusive and sustainable industrialization and foster innovation” of the sustainable development goal (SDGs) established by the United Nations.

What is claimed is:

1. A point cloud decoding device comprising:
a RAHT unit configured to predict information on a chroma Cr signal of a decoding target node by using information on a chroma Cb signal of the decoding target node.

2. The point cloud decoding device according to claim 1, wherein
the RAHT unit predicts a RAHT coefficient value of the chroma Cr signal of the decoding target node by using a RAHT coefficient value of the chroma Cb signal of the decoding target node.

3. The point cloud decoding device according to claim 2, wherein
the RAHT unit calculates the RAHT coefficient value of the chroma Cr signal of the decoding target node by adding a value, which is obtained by multiplying an inversely quantized residual of the chroma Cr signal in a RAHT coefficient domain by a prediction coefficient, to the predicted RAHT coefficient value of the chroma Cr signal of the decoding target node.

4. The point cloud decoding device according to claim 3, wherein
the RAHT unit calculates a prediction coefficient from another already decoded RAHT coefficient residual.

5. The point cloud decoding device according to claim 4, wherein
in the calculation of the prediction coefficient, the RAHT unit calculates the prediction coefficient such that a sum of squared errors is minimized, wherein the sum of squared errors arises from a prediction of the RAHT coefficient residual of the chroma Cb signal, and wherein said prediction is performed by a method comprising: adding a value obtained by multiplying an inversely quantized residual of the chroma Cr signal by said prediction coefficient.

6. The point cloud decoding device according to claim 4, wherein
the RAHT unit uses only a specific number of RAHT coefficient residuals most recently decoded with reference to the RAHT coefficient residual for calculation of the prediction coefficient.

7. The point cloud decoding device according to claim 1, wherein
the RAHT unit decodes syntax indicating whether or not to predict the chroma Cr signal from the chroma Cb signal, and
when a value of the syntax is “1”, the RAHT unit predicts the chroma Cr signal from the chroma Cb signal.

8. A point cloud decoding method, comprising:
predicting information on a chroma Cr signal of a decoding target node by using information on a chroma Cb signal of the decoding target node.

9. A non-transitory computer-readable medium having stored thereon a program for causing a computer to function as a point cloud decoding device, wherein
the point cloud decoding device includes a RAHT unit configured to predict information on a chroma Cr signal of a decoding target node by using information on a chroma Cb signal of the decoding target node.
